(19) United States
(12) Patent Application Publication
(10) Pub. No.: US 2018/0133749 A1
(43) Pub. Date: May 17, 2018

(54) METHOD FOR PRODUCING COATED ARTICLE

(71) Applicant: FUJI XEROX CO., LTD., Tokyo (JP)

(72) Inventors: Takeshi AGATA, Kanagawa (JP); Susumu YOSHINO, Kanagawa (JP); Shigeru SEITOKU, Kanagawa (JP)

(73) Assignee: FUJI XEROX CO., LTD., Tokyo (JP)

(21) Appl. No.: 15/667,735

(22) Filed: Aug. 3, 2017

(30) Foreign Application Priority Data
Nov. 11, 2016 (JP) 2016-220959

(51) Int. Cl. B05D 1/00

(52) U.S. Cl. CPC B05D 1/007

(57) ABSTRACT

A method for producing a coated article includes electrostatically attaching, to a base article to be coated, a first powder coating material including first powder particles containing a thermosetting resin and a thermosetting agent; electrostatically attaching, to the base article having the first powder coating material electrostatically attached, a second powder coating material including second powder particles; and heating the first and second powder coating materials electrostatically attached to the base article, to form a coating film, wherein a volume percent D5c1 of the first powder particles having a particle size of 5 μm or less in the first powder coating material electrostatically attached to the base article, and a volume percent D5o1 of the first powder particles having a particle size of 5 μm or less in the first powder coating material to be ejected, satisfy: Formula: D5o1×0.8≤D5c1≤D5o1×1.2.

### CROSS-REFERENCE TO RELATED APPLICATIONS

This application is based on and claims priority under 35 USC 119 from Japanese Patent Application No. 2016-220959 filed Nov. 11, 2016.

### BACKGROUND

### (i) Technical Field

The present invention relates to a method for producing a coated article.

### (ii) Related Art

Powder coating techniques using powder coating materials have been attracting attention as environmentally safer techniques because the coating processes emit less amount of volatile organic compounds (VOC) and, after the coating processes, powder coating materials not adhering to the coated articles can be collected and used again. With such a trend toward employment of powder coating techniques, various powder coating materials for powder coating techniques are being researched.

### SUMMARY

According to an aspect of the invention, there is provided a method for producing a coated article, the method including:

electrostatically attaching, to a base article to be coated, a first powder coating material including first powder particles containing a thermosetting resin and a thermosetting agent, the first powder coating material being charged;

electrostatically attaching, to the base article having the first powder coating material electrostatically attached, a second powder coating material including second powder particles containing a thermosetting resin and a thermosetting agent, the second powder coating material being charged; and

heating the first powder coating material and the second powder coating material electrostatically attached to the base article, to form a coating film,

wherein a volume percent D5c1 of the first powder particles having a particle size of 5 μm or less in the first powder coating material electrostatically attached to the base article, and a volume percent D5o1 of the first powder particles having a particle size of 5 μm or less in the first powder coating material to be ejected, satisfy:

D5o1×0.8≤D5c1≤D5o1×1.2. Formula:

### DETAILED DESCRIPTION

Hereinafter, exemplary embodiments of the invention will be described in detail.

### Method for Producing Coated Article

A method for producing a coated article according to this exemplary embodiment includes a step of electrostatically attaching, to a base article to be coated, a first powder coating material including first powder particles containing a thermosetting resin and a thermosetting agent, the first powder coating material being charged (hereafter, sometimes referred to as the “first attachment step”); a step of electrostatically attaching, to the base article having the first powder coating material electrostatically attached, a second powder coating material including second powder particles containing a thermosetting resin and a thermosetting agent, the second powder coating material being charged (hereafter, sometimes referred to as the “second attachment step”); and a step of heating the first powder coating material and the second powder coating material electrostatically attached to the base article, to form a coating film (hereafter, sometimes referred to as the “baking step”), wherein a volume percent D5c1 of the first powder particles having a particle size of 5 μm or less in the first powder coating material electrostatically attached to the base article (hereafter, the first powder particles in the first powder coating material electrostatically attached to the base article are sometimes referred to as the “attached first powder coating material”), and a volume percent D5o1 of the first powder particles having a particle size of 5 μm or less in the first powder coating material to be ejected (hereafter, the first powder particles in the first powder coating material to be ejected are sometimes referred to as the “pre-ejection first powder coating material”), satisfy:

D5o1×0.80≤D5c1≤D5o1×1.20. Formula:

Incidentally, the first powder coating material and the second powder coating material may be transparent coating materials (clear coating materials) not containing coloring agents in powder particles or may be colored coating materials containing coloring agents in powder particles. However, the second powder coating material is preferably a transparent coating material; and the first powder coating material is preferably a colored powder coating material, and the second powder coating material is preferably a transparent coating material. This is because a coating film protected by a highly transparent cured film of the transparent coating material is obtained, and the transparency of a cured film of the first powder coating material is less likely to be degraded, to thereby provide a highly colored coating film.

Conventionally, methods for producing a coated article (electrostatic powder coating processes) employ electrostatic powder coating machines such as a corona gun, a tribo gun, and a bell gun to eject powder coating materials.

An example of conventional methods for producing a coated article is a two-coat two-bake method of ejecting a first powder coating material, heating the powder coating material electrostatically attached to a base article to form a coating film, subsequently ejecting a second powder coating material, and heating the powder coating material electrostatically attached to the base article to form a coating film.

There is another method for producing a coated article that is a two-coat one-bake method of ejecting a first powder coating material including first powder particles, ejecting a second powder coating material, and heating the first and second powder coating materials electrostatically attached to the base article to form a coating film. In this method, when the volume percent of the first powder particles having a particle size of 5 μm or less in the first powder coating material electrostatically attached to the base article is considerably different from the volume percent of the first powder particles having a particle size of 5 μm or less in the first powder coating material to be ejected (unused), the resultant coated article has color unevenness.

This is because the percent of powder particles having a particle size of 5 μm or less (in other words, fine particles) in the first powder coating material varies; this results in variations in the smoothness of the film (hereafter, sometimes referred to as the “first attachment film”) formed by attaching the first powder coating material to the base article; this results in formation of recesses irregularly distributed in the first attachment film; and this probably makes color unevenness more noticeable.

When the second powder coating material is further electrostatically attached to the base article having the first powder coating material electrostatically attached, the second powder particles tend to adhere to the recesses of the first attachment film.

When heating is performed in this state to form a coating film, even though the heating causes the first attachment film to melt, the recesses probably tend not to become flat. Thus, a cured film formed from the first powder coating material (hereafter, sometimes referred to as the “first cured film”) has low-smoothness portions.

In summary, since the percent of powder particles having a particle size of 5 μm or less in the first powder coating material varies, the recesses are irregularly distributed; as a result, the first cured film has variations in smoothness, which probably causes color unevenness.

To the recesses, powder particles having a particle size of 5 μm or less in the second powder coating material probably tend to adhere. Thus, when the percent of powder particles having a particle size of 5 μm or less in the second powder coating material varies, the second attachment film also has variations in smoothness, which probably causes color unevenness.

When the second powder coating material is a transparent coating material and the film formed by attaching the second powder coating material has variations in smoothness, a cured film formed from the second powder coating material (hereafter, sometimes referred to as the “second cured film”) in the resultant coating film does not provide the effect of suppressing scattering of light. In addition, since the coating film has variations in the thickness, the color of the first cured film observed through the second cured film appears to vary, which probably causes color unevenness of the coated article.

When the second powder coating material is a transparent coating material and the second cured film has variations in the thickness, the cured film (clear film) formed from the transparent coating material has low transparency, which probably results in a low chroma of the resultant coating film.

From the viewpoint of what is described above, in this exemplary embodiment, a volume percent D5c1 of the first powder particles having a particle size of 5 μm or less in the attached first powder coating material, and a volume percent D5o1 of the first powder particles having a particle size of 5 μm or less in the pre-ejection first powder coating material, are set to satisfy Formula: D5o1×0.80≤D5c1≤D5o1×1.20.

When this relationship is satisfied, there is no or little change between the volume percent D5o1 of the pre-ejection first powder particles having a particle size of 5 μm or less and the volume percent D5c1 of the attached first powder particles having a particle size of 5 μm or less.

In other words, the first powder coating material is electrostatically attached to a base article with no or little change from the volume percent D5o1 of the pre-ejection first powder particles having a particle size of 5 μm or less, and the second powder coating material is electrostatically attached to the base article.

### D5o1 and D5c1

In the method for producing a coated article according to this exemplary embodiment, the volume percent D5c1 of the attached first powder particles having a particle size of 5 μm or less, and the volume percent D5o1 of the pre-ejection first powder particles having a particle size of 5 μm or less satisfy Formula: D5o1×0.80≤D5c1≤D5o1×1.20, preferably satisfy Formula: D5o1×0.90≤D5c1≤D5o1×1.10 from the viewpoint of suppression of color unevenness in the coating film.

In order to make the volume percent D5c1 of the attached first powder particles having a particle size of 5 μm or less and the volume percent D5o1 of the pre-ejection first powder particles having a particle size of 5 μm or less satisfy the above-described Formula, for example, the pre-ejection first powder coating material (pre-ejection powder particles) is made to have a uniform charged state (in other words, narrowing of the charging distribution of the pre-ejection first powder coating material (pre-ejection powder particles)). This is achieved by, for example, 1) decreasing the particle size of the pre-ejection first powder particles (for example, the pre-ejection first powder particles are formed so as to have a volume-average particle size of 3 μm or more and 10 μm or less), 2) forming the pre-ejection first powder particles so as to be spherical (for example, the pre-ejection first powder particles are formed so as to have a circularity of 0.96 or more), 3) narrowing the particle size distribution of the pre-ejection first powder particles (for example, the pre-ejection first powder particles are formed so as to have a volume-based particle-size-distribution index GSDv of 1.50 or less), 4) adding an external additive to the pre-ejection first powder coating material (for example, silica particles are added to the powder coating material), or 5) a combination of two or more selected from 1) to 4).

The volume percent of powder particles having a particle size of 5 μm or less is measured by the following method. A “method using a Coulter Multisizer II (manufactured by Beckman Coulter, Inc.)” described later is first performed to determine a volume-based particle size distribution. On the basis of this particle size distribution, the volume percent of the particles having a particle size of 5 μm or less relative to all the particles is calculated.

### D5o2 and D5c2

D5o2 and D5c2 are described as with D5o1 and D5c1 except that, in the above description, D5o1 is replaced by D5o2, D5c1 is replaced by D5c2, the attached first powder particles are replaced by attached second powder particles, and the pre-ejection first powder coating material (pre-ejection first powder particles) is replaced by a pre-ejection second powder coating material (pre-ejection second powder particles).

From the viewpoint of suppressing color unevenness of the coating film, D5c2 and D5o2 preferably satisfy 0.80≤D5c2/D5o2≤1.20, more preferably 0.90≤D5c2/D5o2≤1.10.

When D5c2/D5o2 satisfies such a range, the volume percent of the first powder particles having a particle size of 5 μm or less attached to the base article is close to the volume percent of the second powder particles having a particle size of 5 μm or less attached to the base article. As a result, the smoothness of the film formed by electrostatically attaching the first powder coating material is close to the smoothness of the film formed by electrostatically attaching the second powder coating material. This probably enables further suppression of color unevenness of the coating film.

### Charge Amount

In the method for producing a coated article according to this exemplary embodiment, from the viewpoint of suppressing color unevenness of the coating film, in the step of electrostatically attaching the first powder coating material to a base article and in the step of electrostatically attaching the second powder coating material to the base article, the charge amount (as an absolute value) of each powder coating material electrostatically attached to the base article is preferably about 30 μC/g or less, or 30 μC/g or less.

In the step of electrostatically attaching the first powder coating material to a base article, a charge amount 1 (as an absolute value) of the first powder coating material electrostatically attached to the base article is preferably about 30 μC/g or less, or 30 μC/g or less; in the step of electrostatically attaching the second powder coating material to the base article, a charge amount 2 (as an absolute value) of the second powder coating material electrostatically attached to the base article having the first powder coating material electrostatically attached is preferably about 30 μC/g or less, or 30 μC/g or less; and the difference (as an absolute value) between the charge amount 1 and the charge amount 2 is preferably about 10 μC/g or less, or 10 μC/g or less.

From the viewpoint of suppressing color unevenness of the coating film, the charge amount 1 and the charge amount 2 are each preferably 1.0 μC/g or more (as an absolute value) and 20 μC/g or less (as an absolute value), more preferably 2.0 μC/g or more (as an absolute value) and 15 μC/g or less (as an absolute value).

From the viewpoint of suppressing color unevenness of the coating film, the difference between the charge amount 1 and the charge amount 2 is preferably 5.0 μC/g or less (as an absolute value), more preferably 2.0 μC/g or less (as an absolute value).

In this exemplary embodiment, the charge amount 1 and the charge amount 2 are measured, for the coating film having been formed, with a blow-off charge-amount measurement system (manufactured by TOSHIBA CORPORATION). Alternatively, the charge amount 1 and the charge amount 2 may be measured, during formation of the coating film by the two-coat one-bake method, with a suction system disposed within jets of the coating materials.

In this measurement, changes in the charge amount of particles during coating are measured.

A typical example of such a measurement system commercially available is an EA02 system manufactured by U-TEC Corporation.

When the charge amount 1 of the first powder coating material electrostatically attached to the base article is 30 μC/g or less (as an absolute value), and, in the step of electrostatically attaching the second powder coating material to the base article, the charge amount 2 of the second powder coating material electrostatically attached to the base article having the first powder coating material electrostatically attached is 30 μC/g or less (as an absolute value), and the difference between the charge amount 1 and the charge amount 2 is 10 μC/g or less (as an absolute value), the charge amount of the first powder particles is close to the charge amount of the second powder particles. As a result, the smoothness of the film formed by electrostatically attaching the first powder coating material is close to the smoothness of the film formed by electrostatically attaching the second powder coating material, which probably results in suppression of color unevenness of the coating film.

Hereinafter, the method for producing a coated article according to this exemplary embodiment will be described in detail.

### First Attachment Step

In the first attachment step, a first powder coating material (pre-ejection first powder coating material) including first powder particles (pre-ejection first powder particles) containing a thermosetting resin and a thermosetting agent, the first powder coating material being charged, is ejected to electrostatically attach the first powder coating material to a base article.

Specifically, in the first attachment step, for example, while an electrostatic field is formed between the ejection port of the electrostatic powder coating machine and a surface (conductive surface) to be coated of a base article, the first powder coating material being charged is ejected through the ejection port of the electrostatic powder coating machine, so that the first powder coating material is electrostatically attached to the surface of the base article. Thus, the film of the first powder coating material is formed. Specifically, for example, a voltage is applied across the grounded surface to be coated of the base article as the anode and the electrostatic powder coating machine as the cathode, to form an electrostatic field between the anode and the cathode; thus, the first powder coating material being charged is made to fly to be electrostatically attached to the surface of the base article, to thereby form the film of the powder coating material.

Incidentally, the first attachment step may be performed while the ejection port of the electrostatic powder coating machine and a surface to be coated of the base article are relatively moved with respect to each other.

The electrostatic powder coating machine may be selected from, for example, well-known electrostatic powder coating machines such as a corona gun (a coating machine that ejects a powder coating material being charged by corona discharge), a tribo gun (a coating machine that ejects a powder coating material being charged by triboelectric charge), and a bell gun (a coating machine that centrifugally ejects a powder coating material being charged by corona discharge or triboelectric charge). The ejection conditions for achieving good coating results may be selected from ranges set for guns.

The amount of first powder coating material attached to a surface of the base article is preferably 1.5 g/m² or more and 15.0 g/m² or less (preferably 2.5 g/m² or more and 10.0 g/m² or less) from the viewpoint that the volume percent D5c1 of the attached first powder particles having a particle size of 5 μm or less and the volume percent D5o1 of the pre-ejection first powder particles having a particle size of 5 μm or less satisfy the above-described Formula, and that color unevenness of the coating film is suppressed.

### Second Attachment Step

In the second attachment step, a second powder coating material (pre-ejection second powder coating material) including second powder particles (pre-ejection second powder particles) containing a thermosetting resin and a thermosetting agent, the second powder coating material being charged, is ejected to electrostatically attach the second powder coating material to the base article having the first powder coating material electrostatically attached.

The phrase “to electrostatically attach the second powder coating material to the base article having the first powder coating material electrostatically attached” means that, to the film of the first powder coating material formed in the first attachment step by electrostatically attaching the first powder coating material to a surface to be coated of the base article, the second powder coating material is further electrostatically attached, to thereby form the film of the second powder coating material.

The details of the second attachment step are described as in the above-described first attachment step except that the first attachment step is replaced by the second attachment step, the first powder particles (pre-ejection first powder particles) are replaced by the second powder particles (pre-ejection second powder particles), and the first powder coating material (pre-ejection first powder coating material) is replaced by the second powder coating material (pre-ejection second powder coating material).

### Baking Step

In the baking step, the first powder coating material and the second powder coating material electrostatically attached to the base article are heated to thereby form a coating film. Specifically, heating is performed to melt and cure the powder particles contained in the film of the first powder coating material and the film of the second powder coating material, to thereby form a coating film.

The heating temperature (baking temperature) is selected in accordance with the type of powder coating materials. For example, the heating temperature (baking temperature) is preferably 90° C. or more and 250° C. or less, more preferably 100° C. or more and 220° C. or less, still more preferably 120° C. or more and 200° C. or less. The heating time (baking time) is adjusted in accordance with the heating temperature (baking temperature).

The above-described steps are performed to form a coating film, that is, to coat a base article, to thereby produce a coated article.

The base article to be coated with the powder coating materials is not particularly limited, and examples of the base article include various metal parts, ceramic parts, and resin parts. Such base articles may be pre-shaped articles that are to be shaped into, for example, plate-shaped articles or linear articles, or may be shaped articles used for, for example, electronic components, road vehicles, or interior or exterior building materials. The base articles may be surface-treated articles in which surfaces to be coated are, in advance, subjected to, for example, primer treatment, plating treatment, or electrodeposition coating.

### Powder Coating Materials

Hereinafter, the first powder coating material (pre-ejection first powder coating material) and the second powder coating material (pre-ejection second powder coating material) used for the method for producing a coated article according to this exemplary embodiment will be collectively described in detail. Incidentally, in the following description, the first powder coating material (pre-ejection first powder coating material) and the second powder coating material (pre-ejection second powder coating material) will be described by being referred to as the powder coating material according to this exemplary embodiment.

The powder coating material according to this exemplary embodiment includes powder particles. The powder coating material may optionally contain an external additive.

### Powder Particles

The powder particles contain a thermosetting resin and a thermosetting agent. The powder particles may optionally contain a coloring agent and another additive.

### Thermosetting Resin

The thermosetting resin is a resin having a thermosetting reactive group. Examples of the thermosetting resin include various resins conventionally used for powder particles of powder coating materials.

The thermosetting resin is preferably a water-insoluble (hydrophobic) resin. Use of a water-insoluble (hydrophobic) resin as the thermosetting resin enables a reduction in the environmental dependency of charging characteristics of the powder coating material (powder particles). When the powder particles are produced by an aggregation-coalescence process, in order to achieve emulsification and dispersion in an aqueous medium, the thermosetting resin is preferably a water-insoluble (hydrophobic) resin. Incidentally, the term “water-insoluble (hydrophobic)” means that the amount of the substance soluble in 100 parts by mass of water at 25° C. is less than 5 parts by mass.

The thermosetting resin is, for example, at least one selected from the group consisting of thermosetting (meth)acrylic resins and thermosetting polyester resins. Among thermosetting resins, thermosetting polyester resins are preferable from the viewpoint of, for example, ease of control in terms of triboelectric series during coating, the strength of the coating film, and the appearance of the finished film.

Examples of the thermosetting reactive groups contained in the thermosetting polyester resins include an epoxy group, a carboxyl group, a hydroxyl group, an amido group, an amino group, an acid anhydride group, and a blocked isocyanate group. Of these, preferred are a carboxyl group and a hydroxyl group from the viewpoint of ease of synthesis.

### Thermosetting Polyester Resin

The thermosetting polyester resin is a polyester resin having a thermosetting reactive group. Examples of the thermosetting reactive group contained in the thermosetting polyester resin include an epoxy group, a carboxyl group, a hydroxyl group, an amido group, an amino group, an acid anhydride group, and a blocked isocyanate group. Of these, preferred are a carboxyl group and a hydroxyl group from the viewpoint of ease of synthesis.

The thermosetting polyester resin is, for example, a polycondensate obtained by polycondensation of at least a polybasic acid and a polyhydric alcohol.

Introduction of the thermosetting reactive group to provide the thermosetting polyester resin is performed through adjustment of the amounts of a polybasic acid and a polyhydric alcohol used in the synthesis of the polyester resin. This adjustment provides a thermosetting polyester resin having at least one of a carboxyl group and a hydroxyl group as a thermosetting reactive group.

Alternatively, after synthesis of a polyester resin, a thermosetting reactive group may be introduced to provide a thermosetting polyester resin.

Examples of the polybasic acid include terephthalic acid, isophthalic acid, phthalic acid, methylterephthalic acid, trimellitic acid, pyromellitic acid, and anhydrides of these acids; succinic acid, adipic acid, azelaic acid, sebacic acid, and anhydrides of these acids; maleic acid, itaconic acid, and anhydrides of these acids; fumaric acid, tetrahydrophthalic acid, methyltetrahydrophthalic acid, hexahydrophthalic acid, methylhexahydrophthalic acid, and anhydrides of these acids; cyclohexanedicarboxylic acid, and 2,6-naphthalenedicarboxylic acid.

Examples of the polyhydric alcohol include ethylene glycol, diethylene glycol, propylene glycol, dipropylene glycol, 1,3-butanediol, 1,4-butanediol, 1,5-pentanediol, 1,6-hexanediol, neopentyl glycol, triethylene glycol, bis(hydroxyethyl)terephthalate, cyclohexanedimethanol, octanediol, diethylpropanediol, butylethylpropanediol, 2-methyl-1,3-propanediol, 2,2,4-trimethylpentanediol, hydrogenated bisphenol A, ethylene oxide adducts of hydrogenated bisphenol A, propylene oxide adducts of hydrogenated bisphenol A, trimethylolethane, trimethylolpropane, glycerol, pentaerythritol, trishydroxyethyl isocyanurate, and hydroxypivalyl hydroxypivalate.

The thermosetting polyester resin may be a polycondensate of a polybasic acid, a polyhydric alcohol, and another monomer.

Examples of the other monomer include compounds having a carboxyl group and a hydroxyl group in a single molecule (for example, dimethanolpropionic acid, and hydroxypivalate); monoepoxy compounds (for example, a glycidyl ester of a branched aliphatic carboxylic acid such as “Cardura E10 (manufactured by Shell Chemicals)”); various monohydric alcohols (such as methanol, propanol, butanol, and benzyl alcohol); various monobasic acids (for example, benzoic acid, and p-tert-butylbenzoic acid); and various fatty acids (for example, castor oil fatty acids, coconut oil fatty acids, and soybean oil fatty acids).

The thermosetting polyester resin may have a branched structure or a linear structure.

The thermosetting polyester resin is preferably a polyester resin in which the total of an acid value and a hydroxyl value is about 10 mgKOH/g or more and about 250 mgKOH/g or less, or 10 mgKOH/g or more and 250 mgKOH/g or less, and a number-average molecular weight of 1000 or more and 100,000 or less.

When the total of an acid value and a hydroxyl value satisfies the above-described range, color unevenness of the coating film is suppressed, and the coating film tends to have enhanced mechanical properties. When the number-average molecular weight satisfies the above-described range, color unevenness of the coating film is suppressed, the coating film has enhanced mechanical properties, and the powder coating material tends to have enhanced storage stability.

Incidentally, the acid value and the hydroxyl value of the thermosetting polyester resin are measured in accordance with JIS K-0070-1992. The number-average molecular weight of the thermosetting polyester resin is measured as in the measurement of the number-average molecular weight of a thermosetting (meth)acrylic resin described below.

### Thermosetting (Meth)Acrylic Resin

The thermosetting (meth)acrylic resin is a (meth)acrylic resin having a thermosetting reactive group. Introduction of the thermosetting reactive group to provide the thermosetting (meth)acrylic resin may be performed by using a vinyl monomer having a thermosetting reactive group. The vinyl monomer having a thermosetting reactive group may be a (meth)acrylic monomer (monomer having a (meth)acryloyl group) or a vinyl monomer other than the (meth)acrylic monomer.

Examples of the thermosetting reactive group of the thermosetting (meth)acrylic resin include an epoxy group, a carboxyl group, a hydroxyl group, an amido group, an amino group, an acid anhydride group, and a blocked isocyanate group. Of these, the thermosetting reactive group of the (meth)acrylic resin is preferably at least one selected from the group consisting of an epoxy group, a carboxyl group, and a hydroxyl group from the viewpoint of ease of production of the (meth)acrylic resin. More preferably, at least one thermosetting reactive group is an epoxy group because the powder coating material has high storage stability and the resultant coating film has good appearance.

Examples of the vinyl monomer having an epoxy group as the thermosetting reactive group include various epoxy group-containing chain monomers (for example, glycidyl (meth)acrylate, β-methylglycidyl (meth)acrylate, glycidyl vinyl ether, and allyl glycidyl ether); various (2-oxo-1,3-oxolane) group-containing vinyl monomers (for example, (2-oxo-1,3-oxolane)methyl (meth)acrylate); and various alicyclic epoxy group-containing vinyl monomers (for example, 3,4-epoxycyclohexyl (meth)acrylate, 3,4-epoxycyclohexylmethyl (meth)acrylate, and 3,4-epoxycyclohexylethyl (meth)acrylate).

Examples of the vinyl monomer having a carboxyl group as the thermosetting reactive group include various carboxyl group-containing monomers (for example, (meth)acrylic acid, crotonic acid, itaconic acid, maleic acid, and fumaric acid); monoesters of various α,β-unsaturated dicarboxylic acids and monohydric alcohols having 1 or more and 18 or less carbon atoms (for example, monomethyl fumarate, monoethyl fumarate, monobutyl fumarate, monoisobutyl fumarate, mono tert-butyl fumarate, monohexyl fumarate, monooctyl fumarate, mono 2-ethylhexyl fumarate, monomethyl maleate, monoethyl maleate, monobutyl maleate, monoisobutyl maleate, mono tert-butyl maleate, monohexyl maleate, monooctyl maleate, and mono 2-ethylhexyl maleate), and itaconic monoalkyl esters (for example, monomethyl itaconate, monoethyl itaconate, monobutyl itaconate, monoisobutyl itaconate, monohexyl itaconate, monooctyl itaconate, and mono 2-ethylhexyl itaconate).

Examples of the vinyl monomer having a hydroxyl group as the thermosetting reactive group include various hydroxyl group-containing (meth)acrylates (for example, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, polyethylene glycol mono(meth)acrylate, and polypropylene glycol mono(meth)acrylate); addition reaction products of these various hydroxyl group-containing (meth)acrylates and ε-caprolactone; various hydroxyl group-containing vinyl ethers (for example, 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, and 6-hydroxyhexyl vinyl ether); addition reaction products of these various hydroxyl group-containing vinyl ethers and ε-caprolactone; various hydroxyl group-containing allyl ethers (for example, 2-hydroxyethyl (meth)allyl ether, 3-hydroxypropyl (meth)allyl ether, 2-hydroxypropyl (meth)allyl ether, 4-hydroxybutyl (meth)allyl ether, 3-hydroxybutyl (meth)allyl ether, 2-hydroxy-2-methylpropyl (meth)allyl ether, 5-hydroxypentyl (meth)allyl ether, and 6-hydroxyhexyl (meth)allyl ether); and addition reaction products of these various hydroxyl group-containing allyl ethers and ε-caprolactone.

The thermosetting (meth)acrylic resin may be a copolymer of a (meth)acrylic monomer and another vinyl monomer that does not have a thermosetting reactive group.

Examples of the other vinyl monomer include various α-olefins (for example, ethylene, propylene, and butene-1); various halogenated olefins other than fluoroolefins (for example, vinyl chloride and vinylidene chloride); various aromatic vinyl monomers (for example, styrene, α-methylstyrene, and vinyltoluene); various dieters of unsaturated dicarboxylic acids and monohydric alcohols having 1 or more and 18 or less carbon atoms (for example, dimethyl fumarate, diethyl fumarate, dibutyl fumarate, dioctyl fumarate, dimethyl maleate, diethyl maleate, dibutyl maleate, dioctyl maleate, dimethyl itaconate, diethyl itaconate, dibutyl itaconate, and dioctyl itaconate); various acid anhydride group-containing monomers (for example, maleic anhydride, itaconic anhydride, citraconic anhydride, (meth)acrylic anhydride, and tetrahydrophthalic anhydride); various phosphate group-containing monomers (for example, diethyl-2-(meth)acryloyloxyethyl phosphate, dibutyl-2-(meth)acryloyloxybutyl phosphate, dioctyl-2-(meth)acryloyloxyethyl phosphate, and diphenyl-2-(meth)acryloyloxyethyl phosphate); various hydrolytic silyl group-containing monomers (for example, γ-(meth)acryloyloxypropyltrimethoxysilane, γ-(meth)acryloyloxypropyltriethoxysilane, and γ-(meth)acryloyloxypropylmethyldimethoxysilane); various vinyl aliphatic carboxylate (for example, vinyl acetate, vinyl propionate, vinyl butyrate, vinyl isobutyrate, vinyl caproate, vinyl caprylate, vinyl caprate, vinyl laurate, branched vinyl aliphatic carboxylates having 9 or more and 11 or less carbon atoms, and vinyl stearate); and various vinyl esters of carboxylic acids having a cyclic structure (for example, vinyl cyclohexanecarboxylate, vinyl methylcyclohexanecarboxylate, vinyl benzoate, and vinyl p-tert-butylbenzoate).

Incidentally, for the thermosetting (meth)acrylic resin, when a vinyl monomer other than (meth)acrylic monomers is used as the vinyl monomer having a thermosetting reactive group, an acrylic monomer not having a thermosetting reactive group is additionally used.

Examples of the acrylic monomer not having a thermosetting reactive group include (meth)acrylic alkyl esters (for example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, cyclohexyl (meth)acrylate, 2-ethylhexyl (meth)acrylate, n-octyl (meth)acrylate, isooctyl (meth)acrylate, 2-ethyloctyl (meth)acrylate, dodecyl (meth)acrylate, isodecyl (meth)acrylate, lauryl (meth)acrylate, and stearyl (meth)acrylate); various (meth)acrylic aryl esters (for example, benzyl (meth)acrylate, phenyl (meth)acrylate, and phenoxyethyl (meth)acrylate); various alkylcarbitol (meth)acrylates (for example, ethylcarbitol (meth)acrylate); other various (meth)acrylic esters (for example, isobornyl (meth)acrylate, dicyclopentanyl (meth)acrylate, dicyclopentenyl (meth)acrylate, dicyclopentenyloxyethyl (meth)acrylate, and tetrahydrofurfuryl (meth)acrylate); various amino group-containing unsaturated amide monomers (for example, N-dimethylaminoethyl (meth)acrylamide, N-diethylaminoethyl (meth)acrylamide, N-dimethylaminopropyl (meth)acrylamide, and N-diethylaminopropyl (meth)acrylamide); various dialkylaminoalkyl (meth)acrylates (for example, dimethylaminoethyl (meth)acrylate, and diethylaminoethyl (meth)acrylate); and various amino group-containing monomers (for example, tert-butylaminoethyl (meth)acrylate, tert-butylaminopropyl (meth)acrylate, aziridinylethyl (meth)acrylate, pyrrolidinylethyl (meth)acrylate, and piperidinylethyl (meth)acrylate).

The thermosetting (meth)acrylic resin is preferably an acrylic resin having a number-average molecular weight of about 1,000 or more and about 20,000 or less, or 1,000 or more and 20,000 or less (preferably 1,500 or more and 15,000 or less).

When the number-average molecular weight is within such a range, color unevenness of the coating film is suppressed, and the resultant coating film tends to have enhanced mechanical properties.

The number-average molecular weight of the thermosetting (meth)acrylic resin is measured by gel permeation chromatography (GPC). The molecular weight is measured by GPC with a GPC measurement system HLC-8120GPC manufactured by Tosoh Corporation, with columns TSKgel SuperHM-M (15 cm) manufactured by Tosoh Corporation, with a THF solvent. A molecular weight calibration curve is created with respect to monodisperse polystyrene standard samples; and, by using the calibration curve, the weight-average molecular weight and the number-average molecular weight are calculated on the basis of the measurement results.

Such thermosetting resins may be used alone or in combination of two or more thereof.

The thermosetting resin content relative to the total mass of the powder particles is preferably about 20 mass % or more and about 99 mass % or less, or 20 mass % or more and 99 mass % or less, preferably 30 mass % or more and 95 mass % or less.

Incidentally, when the powder particles are core/shell particles as described later and the thermosetting resin is used as the resin forming the resin shell portion, the above-described thermosetting resin content means a thermosetting resin content relative to the total mass of the core portion and the resin shell portion.

### Thermosetting Agent

The thermosetting agent is selected in accordance with the type of the thermosetting reactive group of the thermosetting resin.

The term “thermosetting agent” means a compound having a functional group that is reactive to a thermosetting reactive group that is an end group of the thermosetting resin.

When the thermosetting reactive group of the thermosetting resin is a carboxyl group, examples of the corresponding thermosetting agent include various epoxy resins (for example, polyglycidyl ethers of bisphenol A); epoxy group-containing acrylic resins (for example, glycidyl group-containing acrylic resins); polyglycidyl ethers of various polyhydric alcohols (for example, 1,6-hexanediol, trimethylolpropane, and trimethylolethane); polyglycidyl esters of various polycarboxylic acids (for example, phthalic acid, terephthalic acid, isophthalic acid, hexahydrophthalic acid, methylhexahydrophthalic acid, trimellitic acid, and pyromellitic acid); various alicyclic epoxy group-containing compounds (for example, bis(3,4-epoxycyclohexyl)methyl adipate); and hydroxyamides (for example, triglycidyl isocyanurate, and β-hydroxyalkylamide).

When the thermosetting reactive group of the thermosetting resin is a hydroxyl group, examples of the corresponding thermosetting agent include blocked polyisocyanate, and aminoplast. Examples of the blocked polyisocyanate include organic diisocyanates such as various aliphatic diisocyanates (for example, hexamethylene diisocyanate, and trimethylhexamethylene diisocyanate), various alicyclic diisocyanates (for example, xylylene diisocyanate, and isophorone diisocyanate), and various aromatic diisocyanates (for example, tolylene diisocyanate, and 4,4′-diphenylmethane diisocyanate); adducts of such organic diisocyanates with respect to, for example, polyhydric alcohols, low-molecular-weight polyester resins (for example, polyester polyol), or water; polymers of such organic diisocyanates (polymers also including isocyanurate-type polyisocyanate compounds); various polyisocyanate compounds, such as isocyanate-biuret compounds, that are blocked with known and commonly used blocking agents; and self-blocked polyisocyanate compounds having a uretdione bond as a structural unit.

When the thermosetting reactive group of the thermosetting resin is an epoxy group, examples of the corresponding thermosetting agent include acids such as succinic acid, glutaric acid, adipic acid, pimelic acid, suberic acid, azelaic acid, sebacic acid, dodecanedioic acid, eicosanedioic acid, maleic acid, citraconic acid, itaconic acid, glutaconic acid, phthalic acid, trimellitic acid, pyromellitic acid, tetrahydrophthalic acid, hexahydrophthalic acid, cyclohexene-1,2-dicarboxylic acid, trimellitic acid, and pyromellitic acid; anhydrides of these acids; and urethane modified products of these acids. Of these, the thermosetting agent is preferably selected from aliphatic dibasic acids from the viewpoint of properties of the resultant coating film and storage stability; in particular, the thermosetting agent is preferably dodecanedioic acid from the viewpoint of properties of the resultant coating film.

Such thermosetting agents may be used alone or in combination of two or more thereof.

The thermosetting agent content relative to the thermosetting resin is preferably about 1 mass % or more and about 30 mass % or less, or 1 mass % or more and 30 mass % or less, preferably 3 mass % or more and 20 mass % or less.

Incidentally, when the powder particles are core/shell particles as described later and the thermosetting resin is used as the resin forming the resin shell portion, the above-described thermosetting agent content means a thermosetting agent content relative to the total thermosetting-resin mass in the core portion and the resin shell portion.

### Coloring Agent

Examples of the coloring agent include pigments. As the coloring agent, a pigment and a dye may be used in combination.

Examples of the pigment include inorganic pigments such as iron oxide (for example, iron oxide red), titanium oxide, titanium yellow, zinc white, white lead, zinc sulfide, lithopone, antimony oxide, cobalt blue, and carbon black; and organic pigments such as quinacridone red, phthalocyanine blue, phthalocyanine green, permanent red, Hansa yellow, indanthrene blue, brilliant fast scarlet, and benzimidazolone yellow.

Other examples of the pigment include brilliant pigments. Examples of the brilliant pigments include pearl pigments; metal powders such as aluminum powders and stainless steel powders; metal flakes; glass beads; glass flakes; mica; and micaceous iron oxide (MIO).

Such coloring agents may be used alone or in combination of two or more thereof.

The coloring agent content is selected in accordance with, for example, the type of pigment and the target color, lightness, and depth of the coating film.

For example, the coloring agent content relative to the total resin mass of the powder particles is preferably about 1 mass % or more and about 70 mass % or less, or 1 mass % or more and 70 mass % or less, more preferably 2 mass % or more and 60 mass % or less.

The powder particles may contain, as coloring agents, a white pigment and another color (other than white) pigment. When the powder particles contain such a color pigment and a white pigment, the resultant coating film masks the color of the surface of the base article, which enhances color formation of the color pigment. Incidentally, examples of the white pigment include well-known white pigments such as titanium oxide, barium sulfate, zinc oxide, and calcium carbonate. Of these, titanium oxide is preferred because it has a high degree of whiteness (in other words, it has a high masking capability).

### Divalent or Higher Metal Ions

The powder particles may contain divalent or higher metal ions (hereafter, sometimes simply referred to as “metal ions”). As described later, when the powder particles are core/shell particles, these metal ions are contained in both of the core portion and the resin shell portion of the powder particles.

When the powder particles contain divalent or higher metal ions, the metal ions form ionic cross-linking in the powder particles. For example, functional groups of the thermosetting resin (for example, when a thermosetting polyester resin is used as the thermosetting resin, carboxyl groups or hydroxyl groups of the thermosetting polyester resin) interact with the metal ions to form ionic cross-linking. This ionic cross-linking suppresses a phenomenon (what is called, bleeding) of deposition, to the surfaces of the powder particles, of substances contained within the powder particles (the thermosetting agent and other additives optionally added, such as a coloring agent). This suppression tends to enhance the storability of the powder coating material. When the powder coating material is applied and then cured by heating, the heating breaks the ionic cross-linking, so that the melt viscosity of the powder particles decreases, which facilitates formation of a highly smooth coating film.

Examples of the metal ions include divalent or higher and tetravalent or lower metal ions. Specifically, the metal ions are, for example, at least one species selected from the group consisting of aluminum ions, magnesium ions, iron ions, zinc ions, and calcium ions.

Examples of the supply source (a compound contained, as an additive, in the powder particles) of the metal ions include a metallic salt, an inorganic metallic salt polymer, and a metal complex. Such a metallic salt or an inorganic metallic salt polymer is added, for example, as an aggregation agent to the powder particles when the powder particles are produced by an aggregation-coalescence process.

Examples of the metallic salt include aluminum sulfate, aluminum chloride, magnesium chloride, magnesium sulfate, iron(II) chloride, zinc chloride, calcium chloride, and calcium sulfate.

Examples of the inorganic metallic salt polymer include polyaluminum chloride, polyaluminum hydroxide, polyiron(II) sulfate, and calcium polysulfide.

Examples of the metal complex include metallic salts of aminocarboxylic acids. Specific examples of the metal complex include metallic salts (for example, calcium salts, magnesium salts, iron salts, and aluminum salts) based on known chelates such as ethylenediaminetetraacetic acid, propanediaminetetraacetic acid, nitriletriacetic acid, triethylenetetraminehexaacetic acid, and diethylenetriaminepentaacetic acid.

The supply source of the metal ions may be added, not as an aggregation agent, but as just an additive.

The higher the valence of the metal ions, the higher the probability of formation of networked ionic cross-linking, which contributes to the smoothness of the coating film and the storability of the powder coating material. For this reason, the metal ions are preferably Al ions. Thus, preferred supply sources of the metal ions include aluminum salts (for example, aluminum sulfate, and aluminum chloride), and aluminum salt polymers (for example, polyaluminum chloride, and polyaluminum hydroxide). Furthermore, from the viewpoint of the smoothness of the coating film and the storability of the powder coating material, among supply sources of metal ions of the same valence, inorganic metallic salt polymers are more preferable than metallic salts. Thus, the supply source of the metal ions is particularly preferably aluminum salt polymers (for example, polyaluminum chloride and polyaluminum hydroxide).

The metal ion content relative to the total mass of the powder particles is preferably, from the viewpoint of the smoothness of the coating film and the storability of the powder coating material, about 0.002 mass % or more and about 0.2 mass % or less, or 0.002 mass % or more and 0.2 mass % or less, more preferably 0.005 mass % or more and 0.15 mass % or less.

When the metal ion content is 0.002 mass % or more, the metal ions appropriately form ionic cross-linking, which suppresses bleeding of the powder particles and tends to enhance the storability of the coating material. On the other hand, when the metal ion content is 0.2 mass % or less, excessive formation of ionic cross-linking by metal ions is suppressed, and the smoothness of the coating film tends to be enhanced.

When the powder particles are produced by an aggregation-coalescence process, the supply source of metal ions added as an aggregation agent (a metallic salt or a metallic salt polymer) contributes to control of the particle size distribution and shape of the powder particles.

Specifically, the higher the valence of the metal ions, the narrower the resultant particle size distribution, which is preferable. Further, from the viewpoint of achieving a narrower particle size distribution, among supply sources of metal ions of the same valence, metallic salt polymers are more preferable than metallic salts. For this reason together with the above-described reason, preferred supply sources of the metal ions include aluminum salts (for example, aluminum sulfate, and aluminum chloride) and aluminum salt polymers (for example, polyaluminum chloride, and polyaluminum hydroxide); in particular, aluminum salt polymers (for example, polyaluminum chloride, and polyaluminum hydroxide) are preferred.

When the aggregation agent is added such that the metal ion content is 0.002 mass % or more, aggregation of resin particles in the aqueous medium proceeds, which contributes to achievement of a narrow particle size distribution. In addition, aggregation of resin particles forming resin shell portions proceeds on aggregation particles forming core portions, which contributes to formation of resin shell portions over the whole surfaces of the core portions. On the other hand, when the aggregation agent is added such that the metal ion content is 0.2 mass % or less, excessive formation of ionic cross-linking in aggregation particles is suppressed, and fusion and coalescence of the aggregation particles provide more spherical powder particles. For this reason together with the above-described reason, the metal ion content is preferably 0.002 mass % or more and 0.2 mass % or less, more preferably 0.005 mass % or more and 0.15 mass % or less.

The metal ion content is determined by subjecting the powder particles to quantitative analysis of the intensity of fluorescent X-rays. Specifically, for example, the resin and the supply source of metal ions are first mixed to obtain a resin mixture having a known concentration of the metal ions. This resin mixture (200 mg) is shaped with a machine of forming pellets having a diameter of 13 mm, to obtain a pellet sample. The mass of this pellet sample is accurately measured. The pellet sample is subjected to measurement of the intensity of fluorescent X-rays and the peak intensity of fluorescent X-rays is determined. Similarly, other pellet samples having different amounts of the supply source of metal ions are measured, and a calibration curve is drawn on the basis of the results. On the basis of this calibration curve, the metal ion content of the powder particles as the measurement target is subjected to quantitative analysis.

Examples of a method of adjusting the metal ion content include 1) a method of adjusting the amount of supply source of metal ions added; and 2) in the case of producing powder particles by an aggregation-coalescence process, a method in which, in the aggregation step, an aggregation agent (for example, a metallic salt or a metallic salt polymer) is added as the supply source of metal ions, and, at the end of the aggregation step, a chelating agent (for example, EDTA (ethylenediaminetetraacetic acid), DTPA (diethylenetriaminepentaacetic acid), or NTA (nitrilotriacetic acid)) is added to form a complex between the chelating agent and the metal ions, and, for example, in a subsequent washing step, the complex salt is removed, to thereby adjust the metal ion content.

### Another Additive

Examples of the other additive include various additives used for powder coating materials.

Specific examples of the other additive include anti-foaming (bubble) agents (for example, benzoin, and benzoin derivatives), curing accelerators (for example, amine compounds, imidazole compounds, and cationic polymerization catalysts), surface control agents (leveling agents), plasticizers, charge control agents, antioxidants, pigment dispersing agents, flame retardants, and fluidizing agents.

### Core/Shell Particles

In this exemplary embodiment, the powder particles may be core/shell particles including a core portion containing a thermosetting resin and a thermosetting agent, and a resin shell portion covering the surface of the core portion.

The core portion may optionally contain, in addition to the thermosetting resin and the thermosetting agent, the above-described other additives such as a coloring agent.

Hereinafter, the resin shell portions of the core/shell particles will be described.

The resin shell portions may be formed of resin only, or may further contain other components (for example, the thermosetting agent described as a component constituting the core portions, and other additives).

However, from the viewpoint of suppressing bleeding, the resin shell portions are preferably formed of resin only. Incidentally, even when the resin shell portions contain components other than resin, the resin content relative to the total mass of the resin shell portions is preferably 90 mass % or more (preferably 95 mass % or more).

The resin constituting the resin shell portions may be a non-curable resin or a thermosetting resin, and is preferably a thermosetting resin from the viewpoint of increasing the curing density (cross-linking density) of the coating film.

When a thermosetting resin is used as the resin forming the resin shell portions, examples and preferred examples of the thermosetting resin are the same as in the thermosetting resin of the core portions. Incidentally, the thermosetting resin of the resin shell portions may be the same as or different from the thermosetting resin of the core portions.

Alternatively, when a non-curable resin is used as the resin forming the resin shell portions, the non-curable resin is preferably, for example, at least one selected from the group consisting of acrylic resins and polyester resins.

From the viewpoint of suppressing bleeding, the coverage ratio of the resin shell portions is preferably 30% or more and 100% or less, more preferably 50% or more and 100% or less.

The coverage ratio of the resin shell portions over the surfaces of the powder particles is a value determined by XPS (X-ray photoelectron spectroscopy).

Specifically, XPS is performed with a measurement system that is JPS-9000MX manufactured by JEOL Ltd., with an X-ray source that is a MgKα radiation, at an acceleration voltage of 10 kV, and with an emission current of 30 mA.

In the spectrum obtained under such conditions, a peak component derived from the material of the core portions and a peak component derived from the material of the resin shell portions in the surfaces of the powder particles are separated from each other, to thereby determine the coverage ratio of the resin shell portions in the surfaces of the powder particles. This separation into peaks of components is performed by subjecting the measured spectrum to curve fitting according to the least squares method.

Component spectra on the basis of which this separation is performed are obtained by individually measuring the thermosetting resin, the thermosetting agent, the pigment, the additive, and the resin forming the shell portions, which are used for producing the powder particles. The coverage ratio is determined from the ratio of the intensity of a spectrum derived from the resin forming the shell portions to the total intensity of the whole spectrum obtained from the powder particles.

From the viewpoint of suppressing bleeding, the resin shell portions preferably have a thickness of 0.2 μm or more and 4 μm or less, more preferably 0.3 μm or more and 3 μm or less.

The thickness of the resin shell portions is a value measured in the following manner. The powder particles are embedded in, for example, an epoxy resin. This resin is sliced with, for example, a diamond knife to prepare a slice. This slice is observed with, for example, a transmission electron microscope (TEM) and a micrograph including sections of plural powder particles is captured. In the micrograph including sections of powder particles, the thicknesses of the resin shell portions are measured at 20 sites, and the average value of the measured thicknesses is determined as the above-described thickness. When the resin shell portions in the sectional micrograph are not easily observed because, for example, the powder coating material is a clear material, the material may be stained before observation, which facilitates the measurement.

### Preferred Properties of Powder Particles

### Volume-Based Particle-Size-Distribution Index GSDv

From the viewpoint of the smoothness of the coating film and the storability of the powder coating material, the powder particles preferably have a volume-based particle-size-distribution index GSDv of 1.50 or less, more preferably 1.40 or less, still more preferably 1.30 or less. In particular, the powder particles preferably have a volume-based particle-size-distribution index GSDv (in other words, pre-ejection powder particles preferably have a volume-based particle-size-distribution index GSDv) of 1.40 or less from the viewpoint that the volume percent D5c1 or D5c2 of attached powder particles having a particle size of 5 μm or less and the volume percent D5o1 or D5o2 of pre-ejection powder particles having a particle size of 5 μm or less satisfy the above-described Formula.

From the viewpoint of suppressing color unevenness of the coating film, GSDv1 of the first powder particles and GSDv2 of the second powder particles preferably satisfy 0.8≤GSDv1/GSDv2≤1.2, more preferably 0.9≤GSDv1/GSDv2≤1.1.

When 0.9≤GSDv1/GSDv2≤1.1 is satisfied, the particle size distribution of the first powder particles is close to that of the second powder particles, so that the smoothness of the film formed by electrostatically attaching the first powder coating material is close to the smoothness of the film formed by electrostatically attaching the second powder coating material. This probably enables suppression of color unevenness of the coating film.

### Volume-Average Particle Size D50v

From the viewpoint of forming a highly smooth coating film with a small amount of powder particles, the powder particles preferably have a volume-average particle size D50v of 1 μm or more and 25 μm or less, more preferably 2 μm or more and 20 μm or less, still more preferably 3 μm or more and 15 μm or less. In particular, the powder particles preferably have a volume-average particle size D50v (in other words, pre-ejection powder particles preferably have a volume-average particle size D50v) of 3 μm or more and 20 μm or less, more preferably 3 μm or more and 10 μm or less, from the viewpoint that the volume percent D5c1 or D5c2 of the attached powder particles having a particle size of 5 μm or less, and the volume percent D5o1 or D5o2 of the pre-ejection powder particles having a particle size of 5 μm or less satisfy the above-described Formula.

From the viewpoint of suppressing color unevenness of the coating film, D50v1 of the first powder particles and D50v2 of the second powder particles preferably satisfy 0.8≤D50v1/D50v2≤1.2, more preferably 0.9≤D50v1/D50v2≤1.1.

When 0.9≤D50v1/D50v2≤1.1 is satisfied, the volume-average particle size of the first powder particles is close to that of the second powder particles, so that the smoothness of the film formed by electrostatically attaching the first powder coating material is close to the smoothness of the film formed by electrostatically attaching the second powder coating material. This probably enables suppression of color unevenness of the coating film.

### Average Circularity

From the viewpoint of the smoothness of the coating film and the storability of the powder coating material, the powder particles preferably have an average circularity of about 0.96 or more, or 0.96 or more, more preferably 0.97 or more, still more preferably 0.98 or more. In particular, the powder particles preferably have an average circularity (in other words, pre-ejection powder particles preferably have an average circularity) of 0.96 or more from the viewpoint that the volume percent D5c1 or D5c2 of the attached powder particles having a particle size of 5 μm or less, and the volume percent D5o1 or D5o2 of pre-ejection powder particles having a particle size of 5 μm or less satisfy the above-described Formula.

The volume-average particle size D50v and the volume-based particle-size-distribution index GSDv of the powder particles are measured with a Coulter Multisizer II (manufactured by Beckman Coulter, Inc.), and with an electrolyte ISOTON-II (manufactured by Beckman Coulter, Inc.).

In the measurement, 0.5 mg or more and 50 mg or less of the measurement sample is added to 2 ml of a 5% aqueous solution of a surfactant (sodium alkylbenzenesulfonate) as a dispersing agent. The resultant solution is added to 100 ml or more and 150 ml or less of the electrolyte.

The electrolyte in which the sample has been suspended is subjected to dispersion treatment with an ultrasonic dispersing device for 1 minute. A Coulter Multisizer II is used to measure the particle size distribution of particles having a particle size in the range of 2 μm or more and 60 μm or less, through an aperture having an aperture size of 100 μm. Incidentally, the number of particles sampled is 50000.

The particle size distribution measured is divided into particle size ranges (channels). Over these channels, a volume-based cumulative curve is drawn from smaller to larger particle sizes. A particle size corresponding to a cumulative value of 16% is defined as volume-based particle size D16v. A particle size corresponding to a cumulative value of 50% is defined as volume-average particle size D50v. A particle size corresponding to a cumulative value of 84% is defined as volume-based particle size D84v.

A volume-average particle-size-distribution index (GSDv) is calculated as (D84v/D16v)^{1/2}.

The average circularity of the powder particles is measured with a flow particle image analyzer “FPIA-3000 (manufactured by SYSMEX CORPORATION)”. Specifically, to water (100 ml or more and 150 ml or less) from which solid impurities have been removed in advance, a surfactant (alkylbenzenesulfonate, 0.1 ml or more and 0.5 ml or less) is added as a dispersing agent, and further a measurement sample (0.1 g or more and 0.5 g or less) is added. The resultant mixture is subjected to dispersion treatment with an ultrasonic dispersing device for 1 minute or more and 3 minutes or less to prepare a suspension in which the measurement sample is dispersed so as to have a dispersion concentration of 3000 particles/μl or more and 10000 particles/μl or less. This dispersion liquid is measured with the flow particle image analyzer to determine the average circularity of the powder particles.

The average circularity of the powder particles is a value obtained by determining the circularity (Ci) of each of n particles in the powder particles and by performing calculation by the following formula where Ci represents circularity (=circumferential length of a circle having the same projection area as a particle/peripheral length of the projected image of the particle), and fi represents frequency of the powder particles.

$$Average circularity ( Ca ) = ( {\sum }_{i = 1}^{n} ( Ci \times fi ) ) / {\sum }_{i = 1}^{n} ( fi )$$

From the viewpoint of suppressing color unevenness of the coating film, the average circularity Ca1 of the first powder particles and the average circularity Ca2 of the second powder particles preferably satisfy 0.4≤Ca1/Ca2≤1.6, more preferably 0.6≤Ca1/Ca2≤1.6.

When 0.4≤Ca1/Ca2≤1.6 is satisfied, the circularity of the first powder particles is close to the circularity of the second powder particles, so that the smoothness of the film formed by electrostatically attaching the first powder coating material is close to the smoothness of the film formed by electrostatically attaching the second powder coating material. This probably enables suppression of color unevenness of the coating film.

In this exemplary embodiment, from the viewpoint of obtaining a coating film that is protected by a cured product of a transparent coating material and in which color unevenness is suppressed, the first powder particles contained in the first powder coating material preferably contain color powder particles containing a thermosetting resin, a thermosetting agent, and a coloring agent, and the second powder coating material preferably contains transparent powder particles containing a thermosetting resin and a thermosetting agent and substantially not containing a coloring agent.

The phrase “substantially not containing a coloring agent” means that the coloring agent content relative to the total mass of the powder particles is less than 1 mass %, preferably less than 0.1 mass %.

The thermosetting resin and the thermosetting agent contained in the first powder particles may be the same as or different from the thermosetting resin and the thermosetting agent contained in the second powder particles.

In the method for producing a coated article according to this exemplary embodiment, when the above-described relationship D5o1×0.80≤D5c1≤D5o1×1.20 is satisfied, color unevenness of the coated article is suppressed.

### External Additive

An external additive suppresses aggregation of powder particles, so that a highly smooth coating film can be formed with a small amount of powder particles. Specific examples of the external additive include inorganic particles. Examples of the inorganic particles include particles formed of SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂) n, Al₂O₃.2SiO₂, CaCO₃, MgCO₃, BaSO₄, or MgSO₄.

The inorganic particles as an external additive may be subjected to hydrophobic treatment so as to have hydrophobic surfaces. The hydrophobic treatment may be performed by, for example, immersing the inorganic particles in a hydrophobic treatment agent. The hydrophobic treatment agent is not particularly limited and examples thereof include silane coupling agents, silicone oil, titanate coupling agents, and aluminum coupling agents. These hydrophobic treatment agents may be used alone or in combination of two or more thereof.

The amount of hydrophobic treatment agent relative to 100 parts by mass of inorganic particles is normally, for example, 1 part by mass or more and 10 parts by mass or less.

The external additive preferably has a volume-average particle size of 5 nm or more and 200 nm or less, more preferably 7 nm or more and 100 nm or less, still more preferably 10 nm or more and 50 nm or less. When the external additive has a volume-average particle size of 5 nm or more and 200 nm or less, during application of the powder coating material with an electrostatic powder coating machine, the powder particles tend to be divided by the air jet and fly in the form of primary particles. Thus, the powder particles in the form of primary particles tend to be attached to a base article more evenly over the coating surface. This tends to result in suppression of color unevenness.

When the same external additive is added to both of the first powder particles and the second powder particles, the difference in charged state between the powder coating materials is reduced. This further suppresses color unevenness of the coated article.

The amount of external additive externally added relative to the powder particles is preferably, for example, 0.01 mass % or more and 5 mass % or less, more preferably 0.01 mass % or more and 2.0 mass % or less.

### Specific Inorganic Oxide Particles

When the powder particles contain a red pigment and a white pigment, as described above, specific inorganic oxide particles (inorganic oxide particles containing an amino-group-containing silane compound) may be used as an external additive.

### Inorganic Oxide Particles

Examples of the inorganic oxide particles include particles formed of a material such as SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂) n, or Al₂O₃.2SiO₂.

Of these, from the viewpoint of the capability of imparting fluidity to the powder particles and ease of control of the charged state, the material is preferably SiO₂, TiO₂, or Al₂O₃, more preferably SiO₂.

### Amino-Group-Containing Silane Compound

The amino-group-containing silane compound contained in the specific inorganic oxide particles is a compound containing an amino group and a silicon atom (Si). This compound is, from the viewpoint of, for example, production suitability, ease of charge control necessary for providing suitability for the tribo system in this exemplary embodiment, and a broad range of selectivity of material, preferably at least one compound selected from amino-group-containing silane coupling agents and amino-group-containing silicone oils.

These amino-group-containing silane compounds may be used alone or in combination of two or more thereof.

In the amino-group-containing silane coupling agents, preferred examples of the amino group include an unsubstituted amino group, alkylamino groups, and dialkylamino groups. In the alkylamino groups and the dialkylamino groups, examples of the alkyl group include a methyl group, an ethyl group, and a butyl group.

Specific examples of the amino-group-containing silane coupling agents include 3-aminopropyltrimethoxysilane, 3-aminopropylmethyldimethoxysilane, 3-aminopropyltriethoxysilane, 3-aminopropylmethyldiethoxysilane, 3-(N,N-dimethyl)aminopropyltrimethoxysilane, 3-(N,N-diethyl)aminopropyltrimethoxysilane, 3-(N,N-dibutyl)aminopropyltrimethoxysilane, 3-(N,N-dimethyl)aminopropyltriethoxysilane, 3-(N,N-diethyl)aminopropyltriethoxysilane, 3-(N,N-dibutyl)aminopropyltriethoxysilane, 3-(N,N-dimethyl)aminopropylmethyldimethoxysilane, 3-(N,N-diethyl)aminopropylmethyldimethoxysilane, 3-(N,N-dibutyl)aminopropylmethyldimethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, 3-triethoxysilyl-N-(1,3-dimethyl-butylidene)propylamine, N-phenyl-3-aminopropyltrimethoxysilane, N-(vinylbenzyl)-2-aminoethyl-3-aminopropyltrimethoxysilane hydrochloride, 1,2-ethanediamine, N-{3-(trimethoxysilyl)propyl}-, N-{(ethenylphenyl)methyl} derivative hydrochloride, and dimethyl{2-methyl-3-(methylamino)propyl}trimethoxysilane.

Of these, from the viewpoint of a charging capability and ease of production of specific inorganic oxide particles, preferred are aminopropyl-group-containing trimethoxysilane, aminopropyl-group-containing dimethoxysilane, aminopropyl-group-containing triethoxysilane, and aminopropyl-group-containing diethoxysilane. Specifically, preferred is dimethyl{2-methyl-3-(methylamino)propyl}trimethoxysilane.

Incidentally, such an amino-group-containing silane coupling agent may be used in combination with, as a charging-control adjusting agent or a fluidity adjusting agent, for example, a known silane compound such as a silane compound not containing an amino group represented by hexamethyldisilazane, or a silane coupling agent not containing an amino group.

Examples of the amino-group-containing silicone oils include an amino-modified silicone oil in which an organic group containing an amino group is introduced into at least one of a side chain and an end of the main chain of polysiloxane.

Specific examples of the introduced organic group containing an amino group include a 2-aminoethyl group, a 3-aminopropyl group, an N-cyclohexyl-3-aminopropyl group, and an N-(2-aminoethyl)-3-aminopropyl group.

Examples of the amino-group-containing silicone oils include commercially available products.

Examples of the commercially available products include products manufactured by Shin-Etsu Chemical Co., Ltd., such as KF-857, KF-868, KF-865, KF-864, KF-869, KF-859, KF-393, KF-860, KF-880, KF-8004, KF-8002, KF-8005, KF-8010, KF-867, X-22-3820W, KF-869, KF-861, X-22-3939A, and KF-877.

Examples of the commercially available products include products manufactured by Dow Corning Toray Co., Ltd., such as BY16-205, FZ-3760, SF8417, BY16-849, BY16-892, FZ-3785, BY16-872, BY16-213, BY16-203, BY16-898, BY16-890, BY16-891, BY16-893, and FZ-3789.

Other examples of the amino-group-containing silane compound include a compound containing an amino group, an alkylamino group, or a dialkylamino group, and a silicon atom (compound not containing an alkoxy group).

Specific examples of this compound include aminomethyltrimethylsilane, dimethylaminodimethylsilane, dimethylaminotrimethylsilane, bis(dimethylamino)methylsilane, allylaminotrimethylsilane, diethylaminodimethylsilane, bis(ethylamino)dimethylsilane, bis(dimethylamino)dimethylsilane, 2-aminoethylaminomethyltrimethylsilane, tris(dimethylamino)silane, bis(dimethylamino)methylvinylsilane, isopropylaminomethyltrimethylsilane, diethylaminotrimethylsilane, butylaminomethyltrimethylsilane, and 3-butylaminopropyltrimethylsilane.

In the specific inorganic oxide particles, the amino-group-containing silane compound may be contained in the inside portions of the inorganic oxide particles, or may be contained in the surface layer portions of the inorganic oxide particles, or may be contained in both of the inside portions and the surface layer portions of the inorganic oxide particles.

From the viewpoint of ease of control in terms of triboelectric series and ease of production, the amino-group-containing silane compound is preferably contained in the surface layer portions of the inorganic oxide particles.

Such an amino-group-containing silane compound may be made to be contained in the inside portions of the inorganic oxide particles by adding the amino-group-containing silane compound in a step of, for example, synthesis, particle formation, or purification of the inorganic oxide particles.

For example, when the inorganic oxide particles are formed of SiO₂, during synthesis of SiO₂ particles (silica particles) by a wet process such as a sol-gel process, an amino-group-containing silane compound is used in the reaction step. This provides specific inorganic oxide particles containing, in the inside portions, the amino-group-containing silane compound.

Such an amino-group-containing silane compound may be made to be contained in the surface layer portions of inorganic oxide particles by, for example, attaching the amino-group-containing silane compound to the surfaces of the inorganic oxide particles by chemical bonding or physical adsorption.

For example, when the amino-group-containing silane compound is an amino-group-containing silane coupling agent, the inorganic oxide particles are subjected to surface treatment using the amino-group-containing silane coupling agent. This provides specific inorganic oxide particles containing, in the surface layer portions, the amino-group-containing silane compound.

This surface treatment may be performed by, for example, immersing the inorganic oxide particles in a surface treatment agent containing the amino-group-containing silane compound. The surface treatment may be performed for a dispersion liquid of inorganic oxide particle sol.

The amino group content in the specific inorganic oxide particles varies depending on the molecular weight of the amino-group-containing silane compound, and may be selected in accordance with the intended charge-amount control effect and the intended fluidity control effect.

From the viewpoint of exhibiting the control effect on charge amounts of powder particles and specific inorganic oxide particles, and production suitability, the amino-group-containing silane compound content relative to the total mass of the specific inorganic oxide particles is, for example, preferably 0.01 mass % or more and 50 mass % or less, more preferably 0.1 mass % or more and 20 mass % or less.

Incidentally, the amino group content of the specific inorganic oxide particles is estimated by determining the nitrogen atom content by elemental analysis using a commonly used apparatus.

### Hydrophobic Treatment Agent

In the above-described case of attaching an amino-group-containing silane compound by chemical bonding or physical adsorption to the surfaces of inorganic oxide particles to obtain the specific inorganic oxide particles, a component other than amino-group-containing silane compounds may be additionally used as long as the control effect in terms of triboelectric series is not degraded.

The component additionally used may be a hydrophobic treatment agent and the hydrophobic treatment agent is not particularly limited. Examples of the hydrophobic treatment agent include silane coupling agents other than amino-group-containing silane compounds, silicone oils other than amino-group-containing silane compounds, titanate coupling agents, and aluminum coupling agents. These hydrophobic treatment agents may be used alone or in combination of two or more thereof.

### Preferred Properties of Specific Inorganic Oxide Particles Volume-Average Particle Size

The volume-average particle size D50v of the specific inorganic oxide particles, which may be selected in consideration of the particle size of the powder particles, is preferably 0.001 μm or more and 1.0 μm or less, more preferably 0.005 μm or more and 0.5 μm or less.

When the specific inorganic oxide particles have a volume-average particle size within such a range, high fluidity is imparted to the powder particles, and a highly smooth coating film can be formed.

Incidentally, the volume-average particle size D50v of the specific inorganic oxide particles is measured by the same method as in the above-described volume-average particle size D50v of the powder coating material.

### Content of Specific Inorganic Oxide Particles

The content F of the specific inorganic oxide particles is calculated by the following Formula (1) from the carbon content CS of the powder particles and the total metal content IS of the inorganic oxide particles.

The content F of the specific inorganic oxide particles is calculated by the Following formula (1).

F=100×IS/(IS+CS) Formula (1):

In Formula (1), CS represents the carbon content of the powder particles measured by X-ray fluorescence analysis, and IS represents the total metal content of the specific inorganic oxide particles measured by X-ray fluorescence analysis.

In general, the main component of the powder particles is resin, and an element forming a large part of the resin is carbon.

On the other hand, the inorganic oxide particles of the specific inorganic oxide particles are represented by MOx (where M represents a metal element, and x represents a natural number), and most of the elements forming the specific inorganic oxide particles belong to M.

The X-ray fluorescence analysis measures element contents in the surface of a measurement sample that is analyzed.

Thus, the content F calculated by Formula (1) represents the coverage ratio of the specific inorganic oxide particles over the surfaces of the powder particles.

### Process of Measuring CS and IS by X-Ray Fluorescence Analysis

As a pretreatment for the sample, 4 g of a powder coating material is press-molded with a press-molding device at 10 t (10,000 kg) for 1 minute.

The resultant measurement sample is measured with a scanning X-ray fluorescence analyzer ZSX Primus II, manufactured by Rigaku Corporation, under the following measurement conditions: qualitative-quantitative measurement, a tube voltage of 60 KV, a tube current of 50 mA, and a measurement time at 40 deg/min.

In this measurement, the elements measured in the specific inorganic oxide particles are Si, Ti, Al, Cu, Zn, Sn, Ce, Fe, Mg, Ba, Ca, K, Na, Zr, and Ca; and IS is the total content of these elements.

### Method for Producing Powder Coating Material

Hereinafter, a method for producing a powder coating material according to this exemplary embodiment will be described.

The powder coating material according to this exemplary embodiment is obtained by producing powder particles and optionally externally adding an external additive to the powder particles.

The powder particles may be produced by a dry process (for example, a kneading-pulverization process) or a wet process (for example, an aggregation-coalescence process, a suspension-polymerization process, or a dissolution-suspension process). However, the method for producing powder particles is not particularly limited to these processes, and a well-known process may be employed.

For example, examples of the dry process include 1) a kneading-pulverization process of kneading, pulverizing, and classifying a thermosetting resin and other raw materials, and a dry process in which particles obtained by the kneading-pulverization process are turned into another shape by a mechanical impact force or thermal energy.

On the other hand, examples of the wet process include 1) an aggregation-coalescence process of mixing a dispersion liquid in which a polymerizable monomer for obtaining a thermosetting resin is subjected to emulsion polymerization, with a dispersion liquid of other raw materials, and causing aggregation and thermal fusion to obtain powder particles; 2) a suspension-polymerization process of suspending a polymerizable monomer for obtaining a thermosetting resin and a solution of other raw materials in an aqueous medium, and causing polymerization; and 3) a dissolution-suspension process of suspending a thermosetting resin and a solution of other raw materials in an aqueous medium and forming particles. Incidentally, the wet processes are preferably used because of less thermal damage.

The powder particles obtained by such a process may be used as core portions (cores), resin particles may be further attached to the cores, and the resin particles and the cores may be thermally fused to obtain powder particles that are core/shell particles.

In particular, the powder particles are preferably obtained by the aggregation-coalescence process from the viewpoint that the volume-based particle-size-distribution index GSDv, the volume-average particle size D50v, and the average circularity can be easily controlled to be within the above-described preferred ranges.

Hereinafter, the aggregation-coalescence process of producing powder particles that are core/shell particles will be described as an example.

Specifically, the Powder Particles are Preferably Produced by

a step of forming first aggregation particles (first-aggregation-particle formation step) in which, in a dispersion liquid in which first resin particles containing a thermosetting resin and a thermosetting agent are dispersed, the first resin particles and the thermosetting agent are aggregated, or, in a dispersion liquid in which composite particles containing a thermosetting resin and a thermosetting agent are dispersed, the composite particles are aggregated;

a step of forming second aggregation particles (second-aggregation-particle formation step) in which a first-aggregation-particle dispersion liquid in which the first aggregation particles are dispersed is mixed with a second-resin-particle dispersion liquid in which resin-containing second resin particles are dispersed, to cause aggregation of the second resin particles with the surfaces of the first aggregation particles, to thereby form second aggregation particles in which the second resin particles adhere to the surfaces of the first aggregation particles; and

a step of fusing and coalescing the second aggregation particles (fusion-coalescence step) in which a second-aggregation-particle dispersion liquid in which the second aggregation particles are dispersed is heated to fuse and coalesce the second aggregation particles.

Incidentally, in the powder particles produced by the aggregation-coalescence process, portions formed by fusion and coalescence of the first aggregation particles are core portions, while the portions formed by fusion and coalescence of the second resin particles adhering to the surfaces of the first aggregation particles are resin shell portions.

Alternatively, when the first aggregation particles formed in the first-aggregation-particle formation step are subjected to, without the second-aggregation-particle formation step, the fusion-coalescence step in which, instead of the second aggregation particles, the first aggregation particles are fused and coalesced, powder particles having a monolayer structure are provided.

Hereinafter, these steps will be described further in detail.

Incidentally, in the following description, a method for producing powder particles containing a coloring agent will be described; however, the coloring agent is an optional component.

### Step of Preparing Dispersion Liquids

Dispersion liquids to be used in the aggregation-coalescence process are first prepared.

Specifically, the dispersion liquids prepared are a first-resin-particle dispersion liquid in which the first resin particles containing a thermosetting resin for the core portions are dispersed; a thermosetting-agent dispersion liquid in which a thermosetting agent is dispersed; a coloring-agent dispersion liquid in which a coloring agent is dispersed; and a second-resin-particle dispersion liquid in which the second resin particles containing a resin for the resin shell portions are dispersed.

Alternatively, instead of the first-resin-particle dispersion liquid and the thermosetting-agent dispersion liquid, a composite-particle dispersion liquid is prepared in which composite particles containing a thermosetting resin for the core portions and a thermosetting agent are dispersed.

In the following description of the steps in the method for producing a powder coating material, the first resin particles, the second resin particles, and the composite particles will be collectively referred to as “resin particles”, and the dispersion liquids of these resin particles will be referred to as “resin-particle dispersion liquids”.

The resin-particle dispersion liquids are prepared by, for example, dispersing the resin particles in a dispersion medium with a surfactant.

Examples of the dispersion medium used for the resin-particle dispersion liquids include aqueous media.

Examples of the aqueous media include water such as distilled water and ion-exchanged water; and alcohols. These aqueous media may be used alone or in combination of two or more thereof.

Examples of the surfactant include anionic surfactants such as sulfate salt-based surfactants, sulfonate-based surfactants, phosphate-based surfactants, and soap-based surfactants; cationic surfactants such as amine salt-based surfactants and quaternary ammonium salt-based surfactants; and nonionic surfactants such as polyethylene glycol-based surfactants, alkylphenol ethylene-oxide adduct-based surfactants, and polyhydric alcohol-based surfactants. Of these, the anionic surfactants and the cationic surfactants may be used. A nonionic surfactant may be used in combination with an anionic surfactant or a cationic surfactant.

These surfactants may be used alone or in combination of two or more thereof.

Examples of the method of dispersing resin particles in dispersion media for preparation of resin-particle dispersion liquids include commonly used dispersion methods using rotary-shear homogenizers or mills using media such as a ball mill, a sand mill, and a DYNO-MILL. Resin particles of some types may be dispersed in resin-particle dispersion liquids by a phase inversion emulsification, for example.

This phase inversion emulsification is a method in which a resin to be dispersed is dissolved in a hydrophobic organic solvent in which the resin is soluble; a base is added to neutralize the organic continuous phase (O phase); an aqueous medium (W phase) is subsequently added, to cause resin inversion from W/O to O/W (what is called, phase inversion) to form a discontinuous phase, to thereby disperse the resin in the form of particles in the aqueous medium.

Specific examples of the method for preparing the resin-particle dispersion liquids are as follows.

For example, when such a resin-particle dispersion liquid is a polyester-resin-particle dispersion liquid in which polyester resin particles are dispersed, this polyester-resin-particle dispersion liquid is obtained by subjecting raw material monomers to heat-melting and polycondensation under a reduced pressure, by dissolving the resultant polycondensate by addition of a solvent (for example, ethyl acetate), and by subjecting the resultant solution to stirring under addition of a weak alkaline aqueous solution and to phase inversion emulsification.

When the resin-particle dispersion liquid is a composite-particle dispersion liquid, a thermosetting resin and a thermosetting agent are mixed and dispersed in a dispersion medium (for example, emulsification such as phase inversion emulsification), to thereby obtain the composite-particle dispersion liquid.

The volume-average particle size of the resin particles dispersed in the resin-particle dispersion liquid is, for example, preferably 1 μm or less, preferably 0.01 μm or more and 1 μm or less, more preferably 0.08 μm or more and 0.8 μm or less, still more preferably 0.1 μm or more and 0.6 μm or less.

Incidentally, the volume-average particle size of the resin particles is measured in the following manner. The resin particles are measured with a laser diffraction particle size distribution measurement system (for example, LA-700, manufactured by HORIBA, Ltd.) to obtain a particle size distribution. The particle size distribution is divided into particle size ranges (channels). Over these channels, a volume-based cumulative curve is drawn from the smaller to larger particle sizes. A particle size corresponding to a cumulative value of 50% relative to all the particles is determined as a volume-average particle size D50v. Incidentally, the volume-average particle sizes of particles in other dispersion liquids are also similarly measured.

The resin-particle dispersion liquids may be produced by known emulsification processes. In particular, phase inversion emulsification is effective because the resultant particle size distribution is narrow, and the volume-average particle size is easily set to be within the range of 1 μm or less (in particular, 0.08 μm or more and 0.40 μm or less).

In the phase inversion emulsification, a resin is dissolved in an organic solvent in which the resin is soluble, and further in a solvent containing an amphiphilic organic solvent alone or a solvent mixture containing an amphiphilic organic solvent, to thereby form an oil phase. A small amount of basic compound is added dropwise to the oil phase being stirred; water is further added dropwise in small portions to the oil phase being stirred, so that water droplets are incorporated into the oil phase. Subsequently, when the amount of water dropped exceeds a certain amount, inversion occurs between the oil phase and the aqueous phase, so that the oil phase is turned into oil droplets. After that, a step of removing the solvent under a reduced pressure is performed to provide an aqueous dispersion liquid.

The amphiphilic organic solvent is a solvent having a solubility in water at 20° C. of at least 5 g/L or more, desirably 10 g/L or more. When the solubility is less than 5 g/L, the amphiphilic organic solvent poorly provides the effect of increasing the hydrophilization rate, and the resultant aqueous dispersion has poor storage stability, which are problematic. Examples of the amphiphilic organic solvent include alcohols such as ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol; ketones such as methyl ethyl ketone, methyl isobutyl ketone, ethyl butyl ketone, cyclohexanone, and isophorone; ethers such as tetrahydrofuran and dioxane; esters such as ethyl acetate, n-propyl acetate, isopropyl acetate, n-butyl acetate, isobutyl acetate, sec-butyl acetate, 3-methoxybutyl acetate, methyl propionate, ethyl propionate, diethyl carbonate, and dimethyl carbonate; glycol derivatives such as ethylene glycol, ethylene glycol monomethyl ether, ethylene glycol monoethyl ether, ethylene glycol monopropyl ether, ethylene glycol monobutyl ether, ethylene glycol ethyl ether acetate, diethylene glycol, diethylene glycol monomethyl ether, diethylene glycol monoethyl ether, diethylene glycol monopropyl ether, diethylene glycol monobutyl ether, diethylene glycol ethyl ether acetate, propylene glycol, propylene glycol monomethyl ether, propylene glycol monopropyl ether, propylene glycol monobutyl ether, propylene glycol methyl ether acetate, and dipropylene glycol monobutyl ether; 3-methoxy-3-methylbutanol, 3-methoxybutanol, acetonitrile, dimethylformamide, dimethylacetamide, diacetone alcohol, and ethyl acetoacetate. These solvents may be used alone or in combination of two or more thereof.

A thermosetting polyester resin as a thermosetting resin is neutralized with a basic compound when the resin is dispersed in an aqueous medium. The neutralization reaction between the basic compound and the carboxyl group of the thermosetting polyester resin is the motive power for the hydrophilization. In addition, the electrical repulsion between the generated carboxylanions tends to suppress aggregation of the particles.

Examples of the basic compound include ammonia and organic amine compounds having a boiling point of 250° C. or less. Preferred examples of the organic amine compounds include triethylamine, N,N-diethylethanolamine, N,N-dimethylethanolamine, aminoethanolamine, N-methyl-N,N-diethanolamine, isopropylamine, iminobispropylamine, ethylamine, diethylamine, 3-ethoxypropylamine, 3-diethylaminopropylamine, sec-butylamine, propylamine, methylaminopropylamine, dimethylaminopropylamine, methyliminobispropylamine, 3-methoxypropylamine, monoethanolamine, diethanolamine, triethanolamine, morpholine, N-methylmorpholine, and N-ethylmorpholine.

The basic compound is preferably added in such an amount that it neutralizes at least partially the carboxyl groups contained in the thermosetting polyester resin. That is, the amount of the basic compound added relative to the carboxyl groups is preferably 0.2 equivalents or more and 9.0 equivalents or less, more preferably 0.6 equivalents or more and 2.0 equivalents or less. When the amount is 0.2 equivalents or more, the effect of adding the basic compound tends to be exhibited. When the amount is 9.0 equivalents or less, an excessive increase in the hydrophilicity of the oil phase is probably suppressed, which tends to result in a less broad particle size distribution and a good dispersion liquid.

The resin particle content in the resin-particle dispersion liquid is preferably, for example, 5 mass % or more and 50 mass % or less, more preferably 10 mass % or more and 40 mass % or less.

As with the resin-particle dispersion liquid, for example, the thermosetting-agent dispersion liquid and the coloring-agent dispersion liquid are also prepared. In other words, the volume-average particle size, the dispersion medium, the dispersion method, and the particle content of the resin particles in the resin-particle dispersion liquid apply to coloring agent particles dispersed in the coloring-agent dispersion liquid and thermosetting agent particles dispersed in the thermosetting-agent dispersion liquid.

### First-Aggregation-Particle Formation Step

Subsequently, the first-resin-particle dispersion liquid, the thermosetting-agent dispersion liquid, and the coloring-agent dispersion liquid are mixed.

In the resultant dispersion liquid mixture, the first resin particles, the thermosetting agent, and the coloring agent are subjected to hetero-aggregation to thereby form first aggregation particles that have a particle size close to the particle size of the target powder particles, and that contain the first resin particles, the thermosetting agent, and the coloring agent.

Specifically, for example, an aggregation agent is added to the dispersion liquid mixture, and the dispersion liquid mixture is adjusted in terms of pH so as to become acidic (for example, the pH is 2 or more and 5 or less), and a dispersion stabilizing agent is optionally added; subsequently, heating is performed at the glass transition temperature of the first resin particles (specifically, for example, the glass transition temperature (of the first resin particles) −30° C. or more and the glass transition temperature −10° C. or less) to cause aggregation of particles dispersed in the dispersion liquid mixture. Thus, the first aggregation particles are formed.

Alternatively, the first-aggregation-particle formation step may be performed in the following manner: a composite-particle dispersion liquid containing a thermosetting resin and a thermosetting agent may be mixed with a coloring-agent dispersion liquid; and in the resultant dispersion liquid mixture, the composite particles and the coloring agent may be subjected to hetero-aggregation, to thereby form the first aggregation particles.

The first-aggregation-particle formation step may be performed in the following manner: for example, to the dispersion liquid mixture being stirred with a rotary-shear homogenizer, the aggregation agent is added at room temperature (for example, 25° C.); the dispersion liquid mixture is adjusted in terms of pH so as to be acidic (for example, a pH of 2 or more and 5 or less); optionally, a dispersion stabilizing agent is added; and subsequently the above-described heating is performed.

In this step, the heating is stably performed, so that the relationship represented by D5o1×0.80≤D5c1≤D5o1×1.20 is easily satisfied.

Examples of the aggregation agent include surfactants of a polarity opposite to the polarity of the surfactants added as dispersing agents to dispersion liquid mixtures; metallic salts, metallic salt polymers, and metal complexes. When a metal complex is used as the aggregation agent, the amount of surfactant used is reduced and the charging characteristics are enhanced.

Incidentally, after the aggregation ends, an additive that forms a complex with the metal ion of the aggregation agent or a similar bond may be optionally used. This additive is preferably a chelating agent. Addition of the chelating agent achieves, in the case of excessive addition of the aggregation agent, adjustment of the metal ion content of the powder particles.

The metallic salt, the metallic salt polymer, and the metal complex as aggregation agents are used as the supply sources of metal ions. Examples of these agents are described above.

Examples of the chelating agent include water-soluble chelating agents. Specific examples of the chelating agents include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of chelating agent added relative to 100 parts by mass of the resin particles is, for example, preferably 0.01 parts by mass or more and 5.0 parts by mass or less, preferably 0.1 parts by mass or more and less than 3.0 parts by mass.

### Second-Aggregation-Particle Formation Step

Subsequently, the resultant first-aggregation-particle dispersion liquid in which the first aggregation particles are dispersed is mixed with the second-resin-particle dispersion liquid.

Incidentally, the second resin particles may be particles the same as or different from the first resin particles.

In the dispersion liquid mixture in which the first aggregation particles and the second resin particles are dispersed, aggregation is caused such that the second resin particles adhere to the surfaces of the first aggregation particles, to thereby form second aggregation particles in which the second resin particles adhere to the surfaces of the first aggregation particles.

Specifically, for example, in the first-aggregation-particle formation step, when the first aggregation particles reach a target particle size, the first-aggregation-particle dispersion liquid is mixed with the second-resin-particle dispersion liquid; and the resultant dispersion liquid mixture is heated at a temperature equal to or less than the glass transition temperature of the second resin particles.

Subsequently, the pH of the dispersion liquid mixture is changed to be within a range of, for example, about 6.5 or more and about 8.5 or less, to thereby stop the aggregation.

Incidentally, when the pH is within the above-described range, the relationship represented by D5o1×0.80≤D5c1≤D5o1×1.20 tends to be satisfied.

This provides second aggregation particles formed by aggregation such that the second resin particles adhere to the surfaces of the first aggregation particles.

### Fusion-Coalescence Step

Subsequently, the second-aggregation-particle dispersion liquid in which the second aggregation particles are dispersed is heated, for example, at a temperature equal to or higher than the glass transition temperature of the first and second resin particles (for example, at a temperature equal to or higher than a temperature that is 10° C. to 30° C. higher than the glass transition temperature of the first and second resin particles), to fuse and coalesce the second aggregation particles. Thus, the powder particles are formed.

The steps having been described so far provide the powder particles.

After the fusion-coalescence step is finished, the powder particles formed in the dispersion liquid are subjected to known steps including a washing step, a solid-liquid separation step, and a drying step to provide dry powder particles.

In the washing step, from the viewpoint of charging characteristics, displacement washing with ion-exchanged water may be sufficiently performed. The solid-liquid separation step is not particularly limited, and from the viewpoint of productivity, for example, suction filtration or pressure filtration may be performed. The drying step is also not particularly limited and, from the viewpoint of productivity, may be performed by, for example, freeze drying, flash drying, fluidized-bed drying, or vibrating fluidized-bed drying.

Subsequently, the powder coating material according to this exemplary embodiment is produced by optionally adding, to the resultant dry powder particles, an external additive and by mixing the resultant mixture.

Incidentally, this mixing may be performed with, for example, a V blender, a Henschel mixer, or a Loedige Mixer.

Specifically, the mixing may be performed at a low rpm for about several minutes, and subsequently at a high rpm to enhance the adhesion, which tends to result in satisfaction of the relationship represented by D5o1×0.80≤D5c1≤D5o1×1.20.

Furthermore, optionally, for example, a vibratory sifter or a pneumatic sifter may be used to remove coarse particles from the powder particles.

### EXAMPLES

Hereinafter, this exemplary embodiment will be described further in detail with reference to Examples. However, this exemplary embodiment is not limited to these Examples at all. Incidentally, in the following description, “parts” and “%” are all based on mass unless otherwise specified.

### Method for Measuring Properties of Resin

The following method of measuring properties of a polyester resin is employed.

### Glass Transition Temperature

Specifically, the glass transition temperature (Tg) of the resin is measured in the following manner.

A sample is set to a differential scanning calorimeter equipped with an automatic tangent analysis system (DSC-50 type, SHIMADZU CORPORATION). Liquid nitrogen is set as a cooling medium. The sample is heated at a temperature increase rate of 10° C./min from 0° C. to 100° C. (first temperature-increase step) to obtain a DSC curve. Subsequently, the sample is cooled at a temperature decrease rate of −10° C./min to 0° C., and heated again at a temperature increase rate of 10° C./min from 0° C. to 150° C. (second temperature-increase step) to obtain a DSC curve. In the above-described steps, the sample is held for 10 minutes at each of 0° C. and 100° C.

In the detection part of the measurement system, temperature correction is performed with reference to the melting temperature of a mixture of indium and zinc, and calorie correction is performed with reference to the heat of fusion of indium. The sample is placed into an aluminum pan. The aluminum pan in which the sample is placed, and an empty aluminum pan as a reference are set.

The glass transition temperature of the amorphous resin is determined as, in the endothermic region of the DSC curve of the second temperature-increase step, the temperature at a point of intersection of the baseline and the rising line.

### Acid Value and Hydroxyl Value

The acid value and the hydroxyl value of the resin are measured in accordance with JIS K0070-1992.

### Weight-Average Molecular Weight and Number-Average Molecular Weight

The weight-average molecular weight and the number-average molecular weight of the resin are measured by gel permeation chromatography (GPC). The molecular weight measurement by GPC is performed with a measurement system HLC-8120GPC equipped with SC-8020 (Tosoh Corporation), with two columns TSKgel SuperHM-M (6.0 mm ID×15 cm) (Tosoh Corporation), and with tetrahydrofuran as the eluent. The measurement conditions are as follows: a sample concentration of 0.5 mass %, a flow rate of 0.6 mL/min, a sample injection amount of 10 μL, and a measurement temperature of 40° C. An RI detector is used for detection. The calibration curve is created from the following 10 samples among “polystyrene standard samples, TSK standard” manufactured by Tosoh Corporation: “A-500”, “F-1”, “F-10”, “F-80”, “F-380”, “A-2500”, “F-4”, “F-40”, “F-128”, and “F-700”.

### Production of Blue Powder Particles (PCC1)

### Preparation of Coloring-Agent Dispersion Liquid (C1)

Blue pigment (C.I. Pigment Violet 23 (CROMOPHTAL VIOLET GT, Ciba Japan K. K.): 150 parts
Anionic surfactant (Neogen RK, DAI-ICHI KOGYO SEIYAKU CO., LTD.): 20 parts
Ion-exchanged water: 350 parts

The above-described materials are mixed and dispersed with a high-pressure impact dispersing device Ultimaizer (HJP30006, Sugino Machine Limited) at a maximum dispersion pressure of 240 MPa for 1 hour, and the solid content concentration is adjusted to be 25 mass %, to obtain a coloring-agent dispersion liquid. The coloring-agent dispersion liquid is found to have a volume-average particle size of 0.16 μm.

### Preparation of White Pigment Dispersion Liquid (W1)

Titanium oxide (CR-60, ISHIHARA SANGYO KAISHA, LTD.): 200 parts
Anionic surfactant (Neogen RK, DAI-ICHI KOGYO SEIYAKU CO., LTD.): 10 parts
Ion-exchanged water: 300 parts
1.0 mass % nitric acid aqueous solution: 15 parts

The above-described materials and 600 parts of alumina beads having a diameter of 3 mm (AS ONE Corporation) are placed into a 1000 mL bottle (I-boy, AS ONE Corporation), mixed with a benchtop ball mill at 150 rpm for 24 hours, and adjusted so as to have a solid content concentration of 25 mass %. The resultant dispersion liquid is measured with a laser diffraction particle size analyzer and the volume-average particle size is found to be 0.35 μm.

### Preparation of Polyester Resin-Curing Agent Composite Dispersion Liquid (E1)

While a jacketed 3-liter reaction vessel (BJ-30N, manufactured by TOKYO RIKAKIKAI CO., LTD.) equipped with a condenser, a thermometer, a water dropping device, and an anchor impeller is maintained at 40° C. in a water circulation thermostat, a solvent mixture of 180 parts by mass of ethyl acetate and 80 parts by mass of isopropyl alcohol is added to the reaction vessel, and the following compositions are further added.
Polyester resin (PES1) [polycondensate of terephthalic acid/ethylene glycol/neopentyl glycol/trimethylolpropane (molar ratio=100/60/38/2 (mol %), glass transition temperature=62° C., acid value (Av)=12 mgKOH/g, hydroxyl value (OHv)=55 mgKOH/g, weight-average molecular weight (Mw)=12000, and number-average molecular weight (Mn)=4000]: 240 parts by mass
Blocked isocyanate curing agent VESTAGON B1530 (manufactured by EVONIK Industries): 60 parts by mass
Benzoin: 1.5 parts by mass
Acrylic oligomer (Acronal 4F, manufactured by BASF): 3 parts by mass

After these compositions are added, the content in the reaction vessel is stirred with a three-one motor at 150 rpm to achieve dissolution. Thus, an oil phase is obtained. To this oil phase being stirred, a mixed solution of 1 part by mass of a 10 mass % ammonia aqueous solution and 47 parts by mass of a 5 mass % sodium hydroxide aqueous solution is dropped over 5 minutes. The content in the reaction vessel is mixed for 10 minutes. Furthermore, 900 parts by mass of ion-exchanged water is dropped at a rate of 5 parts by mass per minute to cause phase inversion. Thus, an emulsion is obtained.

Immediately, 800 parts by mass of the obtained emulsion and 700 parts by mass of ion-exchanged water are added to a 2-liter recovery flask. This flask is set to via an evaporator trap an evaporator equipped with a vacuum control unit (manufactured by TOKYO RIKAKIKAI CO., LTD.). While the recovery flask is rotated, the recovery flask is heated in a water bath at 60° C.; while care is taken not to cause bumping, the pressure is reduced to 7 kPa to remove the solvent. When the amount of solvent collected has reached 1,100 parts by mass, the pressure is returned to the ordinary pressure, and the recovery flask is cooled with water to obtain a dispersion liquid. The obtained dispersion liquid has no solvent odor. In this dispersion liquid, the resin particles are found to have a volume-average particle size of 145 nm. After that, an anionic surfactant (Dowfax 2A1, manufactured by The Dow Chemical Company, active component content: 45 mass %) is added in an amount of 2 mass % in terms of active component relative to the resin content of the dispersion liquid, and mixed; and ion-exchanged water is added such that the solid content concentration is adjusted to be 25 mass %. The resultant dispersion liquid is defined as a polyester resin-curing agent composite dispersion liquid (E1).

### Production of Blue Powder Coating Material (PCC1)

### Aggregation Step

Polyester resin-curing agent composite dispersion liquid (E1): 180 parts by mass (solid content: 45 parts by mass)
White pigment dispersion liquid (W1): 160 parts by mass (solid content: 40 parts by mass)
Coloring-agent dispersion liquid (C1): 8 parts by mass (solid content: 2 parts by mass)
Ion-exchanged water: 200 parts by mass

The above-described materials are sufficiently mixed with a homogenizer (ULTRA-TURRAX T50, manufactured by IKA-WERKE GMBH & CO. KG) to provide a dispersion liquid within a round stainless steel flask. Subsequently, a 1.0% nitric acid aqueous solution is used to adjust the pH of the dispersion liquid to 3.5. To this dispersion liquid, 0.50 parts by mass of a 10% polyaluminum chloride aqueous solution is added. This mixture is continuously subjected to dispersing treatment with the ULTRA-TURRAX.

A stirring device and a heating mantle are placed. While the number of rotation of the stirring device is controlled such that the slurry is sufficiently stirred, the slurry is heated to 50° C., held at 50° C. for 15 minutes; subsequently, the particle size of aggregation particles is measured with a Coulter counter [TA-II] (aperture size: 50 μm, manufactured by Beckman Coulter, Inc.), and when the volume-average particle size reaches 5.5 μm, 60 parts by mass of the polyester resin-curing agent composite dispersion liquid (E1) is slowly added as a shell-forming material (addition of shell).

### Fusion-Coalescence Step

Subsequently, the content in the flask is heated to 85° C., and held at the temperature for 2 hours.

### Filtration, Washing, and Drying Steps and External Addition Step

After the reaction ends, the solution within the flask is cooled and filtered to obtain a solid content. Subsequently, this solid content is washed with ion-exchanged water, and subsequently subjected to solid-liquid separation by Nutsche suction filtration, to thereby obtain a solid content again.

Subsequently, this solid content is again dispersed in 3 liter of ion-exchanged water at 40° C., and stirred and washed for 15 minutes at 300 rpm. This washing procedure is repeated five times, and solid-liquid separation is performed by Nutsche suction filtration. The resultant solid content is subjected to vacuum drying for 12 hours to obtain blue powder particles.

Furthermore, 1 part by mass of titanium oxide particles (volume-average particle size: 50 nm) are added relative to 100 parts by mass of the blue powder particles, and mixed with a Henschel mixer at a circumferential speed of 15 m/s for 2 minutes, subsequently at 30 m/s for 2 minutes to obtain a blue powder coating material (PCC1).

### Production of Magenta Powder Coating Material (PCC2)

A magenta powder coating material (PCC2) is produced as with the blue powder coating material (PCC1) except that the pigment in the production of the blue powder coating material (PCC1) is replaced by a magenta pigment (C.I. Pigment Red 122), and 1.5 parts by mass of titanium oxide particles (volume-average particle size: 50 nm) relative to 100 parts by mass of the magenta powder particles are added and mixed with a Henschel mixer at a circumferential speed of 30 m/s for 3 minutes, and subsequently at 10 m/s for 1 minute.

### Production of Yellow Powder Coating Material (PCC3)

A yellow powder coating material (PCC3) is produced as with the blue powder coating material (PCC1) except that the pigment in the production of the blue powder coating material (PCC1) is replaced by a yellow pigment (C.I. Pigment Yellow 17), and 0.5 parts by mass of hydrophobic silicon oxide and 1.5 parts by mass of titanium oxide particles (volume-average particle size: 50 nm) relative to 100 parts by mass of the yellow powder particles are added and mixed with a Henschel mixer at a circumferential speed of 15 m/s for 1 minute, subsequently at 30 m/s for 2 minutes.

### Production of Blue Powder Coating Material (PCC4)

A blue powder coating material (PCC4) is produced as with the blue powder coating material (PCC1) except that the amount of the 10% polyaluminum chloride aqueous solution in the production of the blue powder coating material (PCC1) is changed to 0.70 parts by mass, the heating target temperature after placement of the stirring device and the heating mantle is changed to 55° C., and the mixing with the Henschel mixer is performed only at 30 m/s for 3 minutes. Incidentally, the time taken for the increase to the target temperature is the same as in the production of the blue powder coating material (PCC1).

### Production of Blue Powder Coating Material (PCC5)

A blue powder coating material (PCC5) is produced as with the blue powder coating material (PCC1) except that the amount of 10% polyaluminum chloride aqueous solution in the production of PCC1 is changed to 0.4 parts by mass, the heating target temperature after placement of the stirring device and the heating mantle is changed to 513° C., and the mixing with the Henschel mixer is performed only at 30 m/s for 3 minutes. Incidentally, the time taken for the increase to the target temperature is the same as in the production of the blue powder coating material (PCC1).

### Production of Clear Powder Coating Material (PCCL1)

A clear powder coating material (PCCL1) is produced as with the blue powder coating material (PCC1) except that, in the aggregation step, the white pigment dispersion liquid (W1) and the coloring-agent dispersion liquid (C1) are not used.

### Production of Clear Powder Coating Material (PCCL2)

A clear powder coating material (PCCL2) is produced as with the clear powder coating material (PCCL1) except that the amount of 10% polyaluminum chloride aqueous solution in the production of the clear powder coating material (PCCL1) is changed to 0.7 parts by mass, the heating target temperature after placement of the stirring device and the heating mantle is changed to 55° C., and the mixing with the Henschel mixer is performed only at 30 m/s for 3 minutes. Incidentally, the time taken for the increase to the target temperature is the same as in the clear powder coating material (PCCL1).

### Production of Clear Powder Coating Material (PCCL3)

A clear powder coating material (PCCL3) is produced as with the clear powder coating material (PCCL1) except that the amount of 10% polyaluminum chloride aqueous solution in the production of the clear powder coating material (PCCL1) is changed to 0.9 parts by mass, the heating target temperature after placement of the stirring device and the heating mantle is changed to 58° C., and the mixing with the Henschel mixer is performed only at 30 m/s for 2 minutes. Incidentally, the time taken for the increase to the target temperature is the same as in the clear powder coating material (PCCL1).

### Production of Clear Powder Coating Material (PCCL4)

A clear powder coating material (PCCL4) is produced as with the clear powder coating material (PCCL1) except that the amount of 10% polyaluminum chloride aqueous solution in the production of the clear powder coating material (PCCL1) is changed to 0.8 parts by mass, the heating target temperature after placement of the stirring device and the heating mantle is changed to 56° C., and the mixing with the Henschel mixer is performed only at 30 m/s for 4 minutes. Incidentally, the time taken for the increase to the target temperature is the same as in the clear powder coating material (PCCL1).

### Example 1

### Electrostatic Powder Coating

The first powder coating material is charged into a corona gun XR4-110C (manufactured by ASAHI SUNAC CORPORATION). Incidentally, this powder coating material charged is a pre-ejection (new) first powder coating material.

Over a 30 cm×30 cm square aluminum mirror-finished test panel (base article to be coated), the first powder coating material is ejected from the corona gun XR4-110C (manufactured by ASAHI SUNAC CORPORATION) positioned at a distance of 30 cm from the front surface of the panel (the distance being between the panel and the ejection port of the corona gun) with the corona gun being slid up and down and left and right, to electrostatically attach the first powder coating material to the base article. In the corona gun, the applied voltage is 80 kV; the input air pressure is 0.55 MPa; the ejection amount is 200 g/min; and the amount of powder coating material attached to the panel is 4.0 g/m² or more and 6.0 g/m² or less.

The second powder coating material is charged into a corona gun XR4-110C (manufactured by ASAHI SUNAC CORPORATION). Incidentally, this powder coating material charged is a pre-ejection (new) second powder coating material.

Over the panel to which the first powder coating material has been electrostatically attached, the second powder coating material is ejected from the corona gun XR4-110C (manufactured by ASAHI SUNAC CORPORATION) positioned at a distance of 30 cm from the front surface of the panel (the distance being between the panel and the ejection port of the corona gun) with the corona gun being slid up and down and left and right, to electrostatically attach the second powder coating material to the panel to which the first powder coating material has been electrostatically attached. In the corona gun, the applied voltage is 80 kV; the input air pressure is 0.55 MPa; the amount of ejection is 200 g/min; and the amount of powder coating material attached to the panel is 4.0 g/m² or more and 6.0 g/m² or less.

The panel to which the powder coating materials have been electrostatically attached is placed into a high-temperature chamber set at 180° C. and heated (baked) for 30 minutes. In this way, the panel is subjected to electrostatic powder coating with pre-ejection (new) powder coating materials, to obtain a coated article A.

The first powder coating material and the second powder coating material used are described in Table 1 below.

Another procedure is performed in the following manner. The first powder coating material is electrostatically attached to a panel under the same conditions as described above. The first powder coating material electrostatically attached to the panel is collected, and measurement is performed for the volume percent D5c1 (described as “D5c1” in Table 1) of particles having a particle size of 5 μm or less in the powder particles of the attached powder coating material (attached powder particles). The charge amount (charge amount 1) of the first powder coating material is measured with a blow-off charge-amount measurement system (manufactured by TOSHIBA CORPORATION).

Another measurement is performed for the volume percent D5o1 (described as “D5o1” in Table 1) of particles having a particle size of 5 μm or less in the powder particles (pre-ejection powder particles) of the pre-ejection powder coating material.

Another procedure is performed in the following manner. The first and second powder coating materials are electrostatically attached to a base article under the same conditions as described above. The second powder coating material electrostatically attached to the panel is collected, and measurement is performed for the volume percent D5c2 (described as “D5c2” in Table 1) of particles having a particle size of 5 μm or less in the powder particles of the attached powder coating material (attached powder particles). The charge amount (charge amount 2) of the second powder coating material is measured with a blow-off charge-amount measurement system (manufactured by TOSHIBA CORPORATION).

Another measurement is performed for the volume percent D5o2 (described as “D5o2” in Table 1) of particles having a particle size of 5 μm or less in the powder particles (pre-ejection powder particles) of the pre-ejection powder coating material.

### Evaluation for Color Unevenness

The coated article is observed as to whether color unevenness occurs. The evaluation is performed on the basis of the following evaluation system. G3 and G2 are evaluated as at or above the acceptable level. The results are described in Table 1.

G3: No color unevenness is observed.

G2: Slight color unevenness is observed but it is at an acceptable level.

G1: Some color unevenness at an unacceptable level is observed.

### Examples 2 to 5

Other coated articles A are produced and evaluated as in Example 1 except that the first powder coating material and the second powder coating material are changed to those described in Table 1. The results are described in Table 1.

### Comparative Examples 1 and 2

Other coated articles A are produced and evaluated as in Example 1 except that the first powder coating material and the second powder coating material are changed to those described in Table 1. The results are described in Table 1.

TABLE 1

| | | | | | Comparative | Comparative | | |
|---|---|---|---|---|---|---|---|---|
| | | Example 1 | Example 2 | Example 3 | Example 1 | Example 2 | Example 4 | Example 5 |
| Pre-ejection (new) powder | First powder | PCC1 | PCC2 | PCC3 | PCC4 | PCC5 | PCC1 | PCC1 |
| coating materials | coating material | | | | | | | |
| | Second powder | PCCL1 | PCCL1 | PCCL1 | PCCL1 | PCCL2 | PCCL3 | PCCL4 |
| | coating material | | | | | | | |
| | D5o1 (%) | 4.0 | 3.9 | 5.0 | 7.5 | 7.8 | 4.0 | 4.0 |
| | D50v1 (μm) | 5.8 | 6.2 | 6.5 | 7.5 | 8.5 | 5.8 | 5.8 |
| | GSDv1 | 1.21 | 1.25 | 1.23 | 1.30 | 1.35 | 1.21 | 1.21 |
| | Ca1 | 0.95 | 0.99 | 1.00 | 0.90 | 0.85 | 0.95 | 0.95 |
| | D5o2 (%) | 3.9 | 3.9 | 3.9 | 3.9 | 5.0 | 7.0 | 6.0 |
| | D50v2 (μm) | 5.9 | 5.9 | 5.9 | 5.9 | 7.0 | 8.0 | 7.5 |
| | GSDv2 | 1.23 | 1.23 | 1.23 | 1.23 | 1.25 | 1.35 | 1.29 |
| | Ca2 | 1.00 | 1.00 | 1.00 | 1.00 | 0.98 | 0.85 | 0.95 |
| Electrostatically attached | D5c1 (%) | 3.9 | 3.3 | 4.5 | 5.0 | 10.5 | 3.9 | 3.9 |
| powder coating materials | Charge amount 1 | 5.68 μC/g | 8.75 μC/g | 7 μC/g | 13 μC/g | 20 μC/g | 20 μC/g | 5.68 μC/g |
| | D5c2 (%) | 3.7 | 3.7 | 3.7 | 5.5 | 5.8 | 4.4 | 7.8 |
| | Charge amount 2 | 6.05 μC/g | 6.05 μC/g | 6.05 μC/g | 6.05 μC/g | 30 μC/g | 16 μC/g | 30 μC/g |

| | | | | | | | |
|---|---|---|---|---|---|---|---|
| D5c1/D5o1 | 0.98 | 0.85 | 0.90 | 0.67 | 1.35 | 0.98 | 0.98 |
| D5c2/D5o2 | 0.95 | 0.95 | 0.95 | 1.41 | 1.16 | 0.63 | 1.30 |
| Difference between charge amount 1 and | 0.37 | 2.7 | 0.95 | 6.95 | 10 | 4 | 24.32 |
| charge amount 2 | | | | | | | |
| Evaluation for color unevenness | G3 | G3 | G3 | G1 | G1 | G2 | G2 |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for producing a coated article, the method comprising:
electrostatically attaching, to a base article to be coated, a first powder coating material including first powder particles containing a thermosetting resin and a thermosetting agent, the first powder coating material being charged;
electrostatically attaching, to the base article having the first powder coating material electrostatically attached, a second powder coating material including second powder particles containing a thermosetting resin and a thermosetting agent, the second powder coating material being charged; and
heating the first powder coating material and the second powder coating material electrostatically attached to the base article, to form a coating film,
wherein a volume percent D5c1 of the first powder particles having a particle size of 5 μm or less in the first powder coating material electrostatically attached to the base article, and a volume percent D5o1 of the first powder particles having a particle size of 5 μm or less in the first powder coating material to be ejected, satisfy:
D5o1×0.8≤D5c1≤D5o1×1.2. Formula

2. The method for producing a coated article according to claim 1, wherein the volume percent D5c1 of the first powder particles having a particle size of 5 μm or less in the first powder coating material electrostatically attached to the base article, and the volume percent D5o1 of the first powder particles having a particle size of 5 μm or less in the first powder coating material to be ejected, satisfy
D5o1×0.9≤D5c1≤D5o1×1.1. Formula

3. The method for producing a coated article according to claim 1, wherein a volume percent D5c2 of the second powder particles having a particle size of 5 μm or less in the second powder coating material electrostatically attached to the base article, and a volume percent D5o2 of the second powder particles having a particle size of 5 μm or less in the second powder coating material to be ejected, satisfy
D5o2×0.8≤D5c2≤D5o2×1.2. Formula:

4. The method for producing a coated article according to claim 1, wherein, in each powder coating material, the thermosetting resin is a thermosetting polyester resin.

5. The method for producing a coated article according to claim 4, wherein the thermosetting polyester resin has an acid value and a hydroxyl value and a total of these values is about 10 mgKOH/g or more and about 250 mgKOH/g or less.

6. The method for producing a coated article according to claim 1, wherein, in each powder coating material, the thermosetting resin is a thermosetting (meth)acrylic resin.

7. The method for producing a coated article according to claim 6, wherein the thermosetting (meth)acrylic resin has a number-average molecular weight of about 1,000 or more and about 20,000 or less.

8. The method for producing a coated article according to claim 1, wherein, in each powder coating material, a content of the thermosetting resin relative to a total mass of the powder particles is about 20 mass % or more and about 99 mass % or less.

9. The method for producing a coated article according to claim 1, wherein, in each powder coating material, a content of the thermosetting agent relative to the thermosetting resin is about 1 mass % or more and about 30 mass % or less.

10. The method for producing a coated article according to claim 1, wherein, in each powder coating material, the powder particles contain a coloring agent, and a content of the coloring agent relative to a total resin mass of the powder particles is about 1 mass % or more and about 70 mass % or less.

11. The method for producing a coated article according to claim 1, wherein, in each powder coating material, the powder particles contain a metal that provides divalent or higher ions.

12. The method for producing a coated article according to claim 11, wherein the metal is aluminum.

13. The method for producing a coated article according to claim 11, wherein a content of the metal relative to a total mass of the powder particles is about 0.002 mass % or more and about 0.2 mass % or less.

14. The method for producing a coated article according to claim 1, wherein, in the electrostatically attaching of the first powder coating material to the base article and in the electrostatically attaching of the second powder coating material to the base article, the powder coating materials electrostatically attached to the base article have a charge amount of about 30 μC/g or less as an absolute value.

15. The method for producing a coated article according to claim 1, wherein a charge amount 1 of the first powder coating material electrostatically attached to the base article in the electrostatically attaching of the first powder coating material to the base article, and a charge amount 2 of the second powder coating material electrostatically attached to the base article having the electrostatically attached first powder coating material in the electrostatically attaching of the second powder coating material to the base article, are about 30 μC/g or less as an absolute value.

16. The method for producing a coated article according to claim 15, wherein a difference between the charge amount 1 and the charge amount 2 is about 10 μC/g or less as an absolute value.

17. The method for producing a coated article according to claim 1, wherein, in each powder coating material, the powder particles have an average circularity of about 0.96 or more.

18. The method for producing a coated article according to claim 1, wherein, in each powder coating material, inorganic particles adhere to surfaces of the powder particles.

19. The method for producing a coated article according to claim 18, wherein the inorganic particles are treated with an amino-group-containing silane compound.

20. The method for producing a coated article according to claim 1, wherein the second powder coating material is a transparent coating material.
